(19) United States
(12) Patent Application Publication
(10) Pub. No.: US 2017/0161614 A1
(43) Pub. Date: Jun. 8, 2017

(54) SYSTEMS AND METHODS FOR PREDICTING EMERGENCY SITUATIONS

(71) Applicant: RapidSOS, Inc., New York, NY (US)

(72) Inventors: Anil MEHTA, Makanda, IL (US); Michael John MARTIN, Long Island City, NY (US); Nicholas Edward HORELIK, Long Island City, NY (US)

(21) Appl. No.: 15/371,117

(22) Filed: Dec. 6, 2016

Related U.S. Application Data
(60) Provisional application No. 62/263,899, filed on Dec. 7, 2015.

(51) Int. Cl. G06N 5/02; G06F 17/50

(52) U.S. Cl. CPC G06N 5/022; G06F 17/5009

(57) ABSTRACT

Disclosed are systems and methods for predicting emergency situations. In some embodiments, the systems and methods may generate risk predictions for specific types of emergencies, in a geographic area within a time frame. Disclosed are systems and methods that may send warnings or messages of elevated risk of emergency to subjects and emergency service providers.

### CROSS-REFERENCE

This application claims the benefit of U.S. Provisional Application No. 62/263,899, filed Dec. 7, 2015, which application is incorporated herein in its entirety by reference.

### BACKGROUND

An estimated 240 million 911 phone calls are made each year in the U.S with some areas receiving a large majority of these emergency calls from wireless devices. Through the course of a year, a given public safety answering point and associated emergency response personnel responsible for emergencies within a geographic area will experience a wide range of calls on a day-to-day basis. Such fluctuations are universal for emergency response personnel in countries around the world and can result in substantial understaffing or overstaffing of resources during specific time periods. Resources may be misallocated at the locations that impair the ability of emergency response personnel to respond rapidly to developing emergency situations. Similarly, individuals lack convenient access to information on emergency scenarios for which they may be at risk.

### SUMMARY

The number of emergency requests made to public safety answering points, emergency dispatch centers, emergency management systems, and other such emergency response resources is subject to various factors that affect the type and frequency of such requests. Influential factors can include environmental conditions such as weather events (e.g. snow, rain, freezing temperatures, etc.) that may make road conditions more dangerous for motorists. Non-environmental events can also play a role. For example, an annual home game by the local sports team against a division rival may correlate with increased traffic around the downtown stadium and, in turn, with an increased risk of traffic accidents in that geographic area. A combination of factors may combine to produce elevated risks for certain types of emergencies. For example, triple digit temperatures during an outdoor sporting event with a large audience in attendance may correlate with an elevated risk of heat stroke for athletes and/or attendees.

Because the various factors that influence the risk of an emergency will fluctuate over time, the actual number of emergencies or emergency requests for a particular geographic area during a particular time period will also vary depending on the environmental conditions and/or events in that area during that time period. Currently, emergency response personnel are staffed and assigned without the benefit of a system that accounts for these risk factors. The result is inefficient resource allocation that can lead to inadequate responses to emergencies by overstretched personnel or emergency resources sitting idle due to overstaffing. Furthermore, emergency systems and personnel lack an effective means of warning or communicating with subjects who may be at elevated risk to certain emergency situations.

One major advantage of the systems, methods, and media provided herein is that they provide a means of utilizing historical data on past emergencies, environmental conditions, and events to generate risk predictions for current or future conditions. Such risk predictions generated on a macro level (e.g. for a county) enables the emergency resources for the county to be allocated ahead of time in preparation for peaks or valleys in predicted emergencies. For example, a risk prediction model may generate a risk prediction for elevated risk of traffic accidents in the county based on expected thunderstorms during a holiday season when motorists tend to travel, which may prompt a director in charge of staffing at the county emergency dispatch center to increase the number of officers on highway patrol during that holiday time period.

Another advantage of the systems, methods, and media provided herein is that they enable emergency personnel to communicate with people who are subject to a risk prediction indicating an elevated risk of experiencing an emergency. For example, the elevated risk prediction for thunderstorms during a holiday season is information that an emergency dispatch center may send to motorists in that county as part of a travel warning. This information may be sent pre-emptively to all registered inhabitants of the county before the elevated risk condition is live. Alternatively, this information may be sent to all wireless mobile communication devices in the county while the elevated risk condition is in progress. The warning/information may even be filtered to be sent only to those devices with location information/data indicating the device holder/owner is on the road (e.g. GPS shows device is on the freeway and moving faster than 30 mph).

One other advantage of the systems, methods, and media provided herein is that they enable individuals to query an emergency prediction system to determine their emergency risk level currently or in the future. For example, a person wishing to travel to visit his family in another city for a holiday may require help choosing the safer of two possible routes to reach his destination. He may send his travel information (e.g. departure location, destination location, and mode of transportation) and time of departure to the prediction system and obtain a risk prediction for each of the two routes based on forecasted environmental conditions and/or events along those routes during the time of his trip.

In one aspect, described herein is a computer-implemented emergency prediction system comprising: a digital processing device comprising: at least one processor, an operating system configured to perform executable instructions, a memory, and a computer program including instructions executable by the digital processing device to create an application applying a prediction algorithm to emergency, environmental, and event data to create a prediction model for generating one or more risk predictions, the application comprising: (a) a data module obtaining emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events; (b) a modeling module applying a prediction algorithm to the emergency data, environmental data, and event data to create at least one prediction model for generating at least one risk prediction, wherein the modeling module updates the at least one prediction model to improve prediction accuracy; and (c) a risk module generating a risk prediction by applying the at least one prediction model to data corresponding to a defined emergency, a defined geographic area, and a defined time period. In some embodiments, wherein in (b), the modeling module updates the at least one prediction model by adding data for analysis by the prediction algorithm. In any of the preceding embodiments, wherein in (b), the modeling module updates the at least one prediction model by excluding data from analysis by the prediction algorithm. In any of the preceding embodiments, wherein in (b), the modeling module assigns the risk prediction an accuracy score by comparing the risk prediction to an actual risk, wherein the actual risk corresponds to the defined emergency, the defined geographic area, and the defined time period. In further embodiments, the actual risk comprises a number of emergency requests corresponding to the defined emergency, the defined geographic area, and the defined time period. In further embodiments, the accuracy score is 1 when the risk prediction is within a deviation threshold from the actual risk and the accuracy score is 0 when the risk prediction exceeds a deviation threshold from the actual risk. In yet further embodiments, wherein in (b), the modeling module updates the at least one prediction model when an average of a plurality of accuracy scores for a plurality of risk predictions generated by the prediction model is below an accuracy threshold. In any of the preceding embodiments, wherein the risk prediction comprises a predicted number of emergency requests corresponding to the defined emergency, the defined geographic area, and the defined time period. In some embodiments, the prediction model is created using data comprising historical emergency data. In some embodiments, the prediction model is created using data comprising historical environment data. In some embodiments, the prediction model is created using data comprising historical event data. In some embodiments, the prediction model is created using historical data. In some embodiments, the modeling module repeatedly updates the at least one prediction model over time. In some embodiments, the data corresponding to a defined emergency, a defined geographic area, and a defined time period comprises one or more environmental conditions in the defined geographic area during the defined time period. In some embodiments, the data corresponding to a defined emergency, a defined geographic area, and a defined time period comprises one or more events in the defined geographic area during the defined time period. In some embodiments, the defined emergency comprises one or more emergency types. In some embodiments, the system further comprises a user interface obtaining the data corresponding to a defined emergency, a defined geographic area, and a defined time period. In some embodiments, the data corresponding to a defined emergency, a defined geographic area, and a defined time period is obtained from an emergency management system or emergency dispatch center. In some embodiments, the data corresponding to a defined emergency, a defined geographic area, and a defined time period is obtained from one or more subjects. In some embodiments, the data corresponding to a defined emergency, a defined geographic area, and a defined time period is obtained from one or more subject communication devices. In some embodiments, the system further comprises a communication module sending a warning to one or more subjects located within the defined geographic area during the defined time period when the risk prediction corresponding to the defined emergency, the defined geographic area, and the defined time period exceeds a defined risk threshold. In further embodiments, the warning comprises the risk prediction. In further embodiments, the warning comprises a ratio of the risk prediction relative to the risk threshold. In further embodiments, the communication module obtains subject data from one or more subject communication devices. In yet further embodiments, the communication module receives subject data from the one or more subject communication devices passively without user instruction or actively upon user instruction. In further embodiments, the communication module sends one or more warning updates to the one or more subjects. In further embodiments, the defined risk threshold comprises an average of a plurality of risk predictions corresponding to the defined geographic location. In further embodiments, the defined risk threshold comprises an average of a plurality of risk predictions corresponding to a plurality of defined geographic locations. In further embodiments, the risk prediction must exceed the defined risk threshold by a minimum percentage before the communication module sends a warning to the at least one subject. In further embodiments, the communication module obtains subject data for one or more subjects. In yet further embodiments, the subject data comprises data corresponding to the defined emergency, the defined geographic area, and the defined time period. In yet further embodiments, the subject data comprises current subject data. In yet further embodiments, the subject data comprises historical subject data. In yet further embodiments, the subject data comprises current location at a current time for one or more subjects. In yet further embodiments, the subject data comprises a future location at a future time for one or more subjects. In still yet further embodiments, the future location at the future time is calculated using current subject data, historical subject data, or a combination thereof. In some embodiments, the defined time period comprises at least one time block, wherein a 24 hour time period is divided into a plurality of time blocks. In further embodiments, the plurality of time blocks comprises time blocks of equal length. In further embodiments, the plurality of time blocks comprises time blocks of unequal length. In further embodiments, a time block is about 1 hour. In some embodiments, the defined time period comprises a time of year. In some embodiments, the defined time period comprises one or more days in the week. In some embodiments, the defined time period comprises one or more days in the weekend. In some embodiments, the emergency data comprises data from one or more emergency requests received from one or more subject communication devices. In some embodiments, the emergency data comprises data obtained from one or more emergency management system servers. In some embodiments, the emergency data comprises data obtained from one or more emergency dispatch center servers. In some embodiments, the emergency data comprises current emergency data for the plurality of emergencies. In some embodiments, the emergency data comprises historical emergency data for the plurality of emergencies. In some embodiments, the emergency type is selected from the group consisting of: vehicle emergency, fire emergency, police emergency, and medical emergency. In some embodiments, the emergency location comprises GPS coordinates. In further embodiments, the emergency location comprises a location of the one or more subject communication devices sending the one or more emergency requests. In further embodiments, the emergency time comprises the time when the one or more subject communication devices sent the one or more emergency requests. In further embodiments, the emergency request comprises a phone call. In further embodiments, the emergency request comprises a message. In some embodiments, the environment data comprises historical environment data for the plurality of environmental conditions. In some embodiments, the environment data comprises current environment data for the plurality of environmental conditions. In some embodiments, the environment data comprises future environment data for the plurality of environmental conditions. In further embodiments, the future environment data for each of the plurality of environmental conditions comprises an environment type at an environment location during an environment time, wherein the environment time comprises a future time. In further embodiments, the future environment data comprises a plurality of predicted environment types, each of the plurality of environment types corresponding to an environment location during a future environment time. In further embodiments, the future environment data is calculated using current environment data, historical environment data, or any combination thereof. In some embodiments, the environment type is selected from the group consisting of: traffic condition, weather condition, and road condition. In some embodiments, the environment data is obtained from one or more environmental data servers. In some embodiments, the event data comprises historical event data for the plurality of events. In some embodiments, the event data comprises current event data for the plurality of events. In some embodiments, the event data comprises future event data for the plurality of events. In further embodiments, the future event data for each of the plurality of events comprises an event type at an event location during an event time, wherein the event time comprises a future time. In further embodiments, the future event data comprises a plurality of predicted event types, each of the plurality of event types corresponding to an event location during a future event time. In further embodiments, the future event data is calculated using current event data, historical event data, or any combination thereof. In some embodiments, the event data is obtained from one or more event data servers. In some embodiments, the event type is selected from the group consisting of: concert, sporting event, political demonstration, festival, performance, riot, protest, parade, convention, and political campaign event. In some embodiments, the system receives instructions to provide one or more risk predictions from an emergency management system or emergency dispatch center and sends the one or more risk predictions to the emergency management system or emergency dispatch center. In some embodiments, the emergency management system provides the data corresponding to a defined emergency, a defined geographic area, and a defined time period. In some embodiments, the system provides one or more risk predictions to one or more emergency management systems or emergency dispatch centers, wherein the risk predictions enhance allocation of emergency response resources in preparation for future emergency requests. In some embodiments, the system provides one or more risk predictions to an emergency management system or emergency dispatch center autonomously without requiring instructions requesting one or more risk predictions. In some embodiments, the prediction algorithm generates the prediction model using regression statistical analysis on the emergency data, environmental data, and event data, wherein the statistical analysis is selected from linear regression, logistic regression, polynomial regression, stepwise regression, ridge regression, lasso regression and ElasticNet regression. In some embodiments, the prediction algorithm comprises generating the prediction model using machine learning on the emergency data, environmental data, and event data, wherein the machine learning is selected from Support Vector Machine (SVM), Random Forest (RF), Naïve Bayes Classifier, neural networks, deep neural networks, and logistic regression.

In some aspects, provided herein is non-transitory computer-readable storage media encoded with a computer program including instructions executable by at least one processor to create an emergency prediction application applying a prediction algorithm to emergency, environmental, and event data to create a prediction model for generating one or more risk predictions, the application comprising: (a) a data module obtaining emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events; (b) a modeling module applying a prediction algorithm to the emergency data, environmental data, and event data to create at least one prediction model for generating at least one risk prediction, wherein the modeling module updates the at least one prediction model to improve prediction accuracy; and (c) a risk module generating a risk prediction by applying the at least one prediction model to data corresponding to a defined emergency, a defined geographic area, and a defined time period. In some embodiments, wherein in (b), the modeling module updates the at least one prediction model by adding data for analysis by the prediction algorithm. In any of the preceding embodiments, wherein in (b), the modeling module updates the at least one prediction model by excluding data from analysis by the prediction algorithm. In any of the preceding embodiments, wherein in (b), the modeling module assigns the risk prediction an accuracy score by comparing the risk prediction to an actual risk, wherein the actual risk corresponds to the defined emergency, the defined geographic area, and the defined time period. In further embodiments, the actual risk comprises a number of emergency requests corresponding to the defined emergency, the defined geographic area, and the defined time period. In further embodiments, the accuracy score is 1 when the risk prediction is within a deviation threshold from the actual risk and the accuracy score is 0 when the risk prediction exceeds a deviation threshold from the actual risk. In yet further embodiments, wherein in (b), the modeling module updates the at least one prediction model when an average of a plurality of accuracy scores for a plurality of risk predictions generated by the prediction model is below an accuracy threshold. In any of the preceding embodiments, wherein the risk prediction comprises a predicted number of emergency requests corresponding to the defined emergency, the defined geographic area, and the defined time period. In some embodiments, the prediction model is created using data comprising historical emergency data. In some embodiments, the prediction model is created using data comprising historical environment data. In some embodiments, the prediction model is created using data comprising historical event data. In some embodiments, the prediction model is created using historical data. In some embodiments, the modeling module repeatedly updates the at least one prediction model over time. In some embodiments, the data corresponding to a defined emergency, a defined geographic area, and a defined time period comprises one or more environmental conditions in the defined geographic area during the defined time period. In some embodiments, the data corresponding to a defined emergency, a defined geographic area, and a defined time period comprises one or more events in the defined geographic area during the defined time period. In some embodiments, the defined emergency comprises one or more emergency types. In some embodiments, the application further comprises a user interface obtaining the data corresponding to a defined emergency, a defined geographic area, and a defined time period. In some embodiments, the data corresponding to a defined emergency, a defined geographic area, and a defined time period is obtained from an emergency management system or emergency dispatch center. In some embodiments, the data corresponding to a defined emergency, a defined geographic area, and a defined time period is obtained from one or more subjects. In some embodiments, the data corresponding to a defined emergency, a defined geographic area, and a defined time period is obtained from one or more subject communication devices. In some embodiments, the application further comprises a communication module sending a warning to one or more subjects located within the defined geographic area during the defined time period when the risk prediction corresponding to the defined emergency, the defined geographic area, and the defined time period exceeds a defined risk threshold. In further embodiments, the warning comprises the risk prediction. In further embodiments, the warning comprises a ratio of the risk prediction relative to the risk threshold. In further embodiments, the communication module obtains subject data from one or more subject communication devices. In yet further embodiments, the communication module receives subject data from the one or more subject communication devices passively without user instruction or actively upon user instruction. In further embodiments, the communication module sends one or more warning updates to the one or more subjects. In further embodiments, the defined risk threshold comprises an average of a plurality of risk predictions corresponding to the defined geographic location. In further embodiments, the defined risk threshold comprises an average of a plurality of risk predictions corresponding to a plurality of defined geographic locations. In further embodiments, the risk prediction must exceed the defined risk threshold by a minimum percentage before the communication module sends a warning to the at least one subject. In further embodiments, the communication module obtains subject data for one or more subjects. In yet further embodiments, the subject data comprises data corresponding to the defined emergency, the defined geographic area, and the defined time period. In yet further embodiments, the subject data comprises current subject data. In yet further embodiments, the subject data comprises historical subject data. In yet further embodiments, the subject data comprises current location at a current time for one or more subjects. In yet further embodiments, the subject data comprises a future location at a future time for one or more subjects. In still yet further embodiments, the future location at the future time is calculated using current subject data, historical subject data, or a combination thereof. In some embodiments, the defined time period comprises at least one time block, wherein a 24 hour time period is divided into a plurality of time blocks. In further embodiments, the plurality of time blocks comprises time blocks of equal length. In further embodiments, the plurality of time blocks comprises time blocks of unequal length. In further embodiments, a time block is about 1 hour. In some embodiments, the defined time period comprises a time of year. In some embodiments, the defined time period comprises one or more days in the week. In some embodiments, the defined time period comprises one or more days in the weekend. In some embodiments, the emergency data comprises data from one or more emergency requests received from one or more subject communication devices. In some embodiments, the emergency data comprises data obtained from one or more emergency management system servers. In some embodiments, the emergency data comprises data obtained from one or more emergency dispatch center servers. In some embodiments, the emergency data comprises current emergency data for the plurality of emergencies. In some embodiments, the emergency data comprises historical emergency data for the plurality of emergencies. In some embodiments, the emergency type is selected from the group consisting of: vehicle emergency, fire emergency, police emergency, and medical emergency. In some embodiments, the emergency location comprises GPS coordinates. In further embodiments, the emergency location comprises a location of the one or more subject communication devices sending the one or more emergency requests. In further embodiments, the emergency time comprises the time when the one or more subject communication devices sent the one or more emergency requests. In further embodiments, the emergency request comprises a phone call. In further embodiments, the emergency request comprises a message. In some embodiments, the environment data comprises historical environment data for the plurality of environmental conditions. In some embodiments, the environment data comprises current environment data for the plurality of environmental conditions. In some embodiments, the environment data comprises future environment data for the plurality of environmental conditions. In further embodiments, the future environment data for each of the plurality of environmental conditions comprises an environment type at an environment location during an environment time, wherein the environment time comprises a future time. In further embodiments, the future environment data comprises a plurality of predicted environment types, each of the plurality of environment types corresponding to an environment location during a future environment time. In further embodiments, the future environment data is calculated using current environment data, historical environment data, or any combination thereof. In some embodiments, the environment type is selected from the group consisting of: traffic condition, weather condition, and road condition. In some embodiments, the environment data is obtained from one or more environmental data servers. In some embodiments, the event data comprises historical event data for the plurality of events. In some embodiments, the event data comprises current event data for the plurality of events. In some embodiments, the event data comprises future event data for the plurality of events. In further embodiments, the future event data for each of the plurality of events comprises an event type at an event location during an event time, wherein the event time comprises a future time. In further embodiments, the future event data comprises a plurality of predicted event types, each of the plurality of event types corresponding to an event location during a future event time. In further embodiments, the future event data is calculated using current event data, historical event data, or any combination thereof. In some embodiments, the event data is obtained from one or more event data servers. In some embodiments, the event type is selected from the group consisting of: concert, sporting event, political demonstration, festival, performance, riot, protest, parade, convention, and political campaign event. In some embodiments, the application receives instructions to provide one or more risk predictions from an emergency management system or emergency dispatch center and sends the one or more risk predictions to the emergency management system or emergency dispatch center. In some embodiments, the emergency management system provides the data corresponding to a defined emergency, a defined geographic area, and a defined time period. In some embodiments, the application provides one or more risk predictions to one or more emergency management systems or emergency dispatch centers, wherein the risk predictions enhance allocation of emergency response resources in preparation for future emergency requests. In some embodiments, the application provides one or more risk predictions to an emergency management system or emergency dispatch center autonomously without requiring instructions requesting one or more risk predictions. In some embodiments, the prediction algorithm generates the prediction model using regression statistical analysis on the emergency data, environmental data, and event data, wherein the statistical analysis is selected from linear regression, logistic regression, polynomial regression, stepwise regression, ridge regression, lasso regression and ElasticNet regression. In some embodiments, the prediction algorithm comprises generating the prediction model using machine learning on the emergency data, environmental data, and event data, wherein the machine learning is selected from Support Vector Machine (SVM), Random Forest (RF), Naïve Bayes Classifier, neural networks, deep neural networks, and logistic regression.

In yet another aspect, provided herein is a method of using a digital processing device to apply a prediction algorithm to emergency, environmental, and event data to create a prediction model for generating one or more risk predictions, the method comprising: (a) providing, by the device, a data module receiving emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events; (b) providing, by the device, a modeling module applying a prediction algorithm to the emergency data, environmental data, and event data to create at least one prediction model for generating at least one risk prediction, wherein the device updates the at least one prediction model to improve prediction accuracy; and (c) providing, by the device, a risk model generating a risk prediction by applying the at least one prediction model to data corresponding to a defined emergency, a defined geographic area, and a defined time period. In some embodiments, wherein in (b), the modeling module updates the at least one prediction model by adding data for analysis by the prediction algorithm. In any of the preceding embodiments, wherein in (b), the modeling module updates the at least one prediction model by excluding data from analysis by the prediction algorithm. In any of the preceding embodiments, wherein in (b), the modeling module assigns the risk prediction an accuracy score by comparing the risk prediction to an actual risk, wherein the actual risk corresponds to the defined emergency, the defined geographic area, and the defined time period. In further embodiments, the actual risk comprises a number of emergency requests corresponding to the defined emergency, the defined geographic area, and the defined time period. In further embodiments, the accuracy score is 1 when the risk prediction is within a deviation threshold from the actual risk and the accuracy score is 0 when the risk prediction exceeds a deviation threshold from the actual risk. In yet further embodiments, wherein in (b), the modeling module updates the at least one prediction model when an average of a plurality of accuracy scores for a plurality of risk predictions generated by the prediction model is below an accuracy threshold. In any of the preceding embodiments, wherein the risk prediction comprises a predicted number of emergency requests corresponding to the defined emergency, the defined geographic area, and the defined time period. In some embodiments, the prediction model is created using data comprising historical emergency data. In some embodiments, the prediction model is created using data comprising historical environment data. In some embodiments, the prediction model is created using data comprising historical event data. In some embodiments, the prediction model is created using historical data. In some embodiments, the modeling module repeatedly updates the at least one prediction model over time. In some embodiments, the data corresponding to a defined emergency, a defined geographic area, and a defined time period comprises one or more environmental conditions in the defined geographic area during the defined time period. In some embodiments, the data corresponding to a defined emergency, a defined geographic area, and a defined time period comprises one or more events in the defined geographic area during the defined time period. In some embodiments, the defined emergency comprises one or more emergency types. In some embodiments, the method further comprises providing, by the device, a user interface obtaining the data corresponding to a defined emergency, a defined geographic area, and a defined time period. In some embodiments, the data corresponding to a defined emergency, a defined geographic area, and a defined time period is obtained from an emergency management system or emergency dispatch center. In some embodiments, the data corresponding to a defined emergency, a defined geographic area, and a defined time period is obtained from one or more subjects. In some embodiments, the data corresponding to a defined emergency, a defined geographic area, and a defined time period is obtained from one or more subject communication devices. In some embodiments, the method further comprises providing, by the device, a communication module sending a warning to one or more subjects located within the defined geographic area during the defined time period when the risk prediction corresponding to the defined emergency, the defined geographic area, and the defined time period exceeds a defined risk threshold. In further embodiments, the warning comprises the risk prediction. In further embodiments, the warning comprises a ratio of the risk prediction relative to the risk threshold. In further embodiments, the communication module obtains subject data from one or more subject communication devices. In yet further embodiments, the communication module receives subject data from the one or more subject communication devices passively without user instruction or actively upon user instruction. In further embodiments, the communication module sends one or more warning updates to the one or more subjects. In further embodiments, the defined risk threshold comprises an average of a plurality of risk predictions corresponding to the defined geographic location. In further embodiments, the defined risk threshold comprises an average of a plurality of risk predictions corresponding to a plurality of defined geographic locations. In further embodiments, the risk prediction must exceed the defined risk threshold by a minimum percentage before the communication module sends a warning to the at least one subject. In further embodiments, the communication module obtains subject data for one or more subjects. In yet further embodiments, the subject data comprises data corresponding to the defined emergency, the defined geographic area, and the defined time period. In yet further embodiments, the subject data comprises current subject data. In yet further embodiments, the subject data comprises historical subject data. In yet further embodiments, the subject data comprises current location at a current time for one or more subjects. In yet further embodiments, the subject data comprises a future location at a future time for one or more subjects. In still yet further embodiments, the future location at the future time is calculated using current subject data, historical subject data, or a combination thereof. In some embodiments, the defined time period comprises at least one time block, wherein a 24 hour time period is divided into a plurality of time blocks. In further embodiments, the plurality of time blocks comprises time blocks of equal length. In further embodiments, the plurality of time blocks comprises time blocks of unequal length. In further embodiments, a time block is about 1 hour. In some embodiments, the defined time period comprises a time of year. In some embodiments, the defined time period comprises one or more days in the week. In some embodiments, the defined time period comprises one or more days in the weekend. In some embodiments, the emergency data comprises data from one or more emergency requests received from one or more subject communication devices. In some embodiments, the emergency data comprises data obtained from one or more emergency management system servers. In some embodiments, the emergency data comprises data obtained from one or more emergency dispatch center servers. In some embodiments, the emergency data comprises current emergency data for the plurality of emergencies. In some embodiments, the emergency data comprises historical emergency data for the plurality of emergencies. In some embodiments, the emergency type is selected from the group consisting of: vehicle emergency, fire emergency, police emergency, and medical emergency. In some embodiments, the emergency location comprises GPS coordinates. In further embodiments, the emergency location comprises a location of the one or more subject communication devices sending the one or more emergency requests. In further embodiments, the emergency time comprises the time when the one or more subject communication devices sent the one or more emergency requests. In further embodiments, the emergency request comprises a phone call. In further embodiments, the emergency request comprises a message. In some embodiments, the environment data comprises historical environment data for the plurality of environmental conditions. In some embodiments, the environment data comprises current environment data for the plurality of environmental conditions. In some embodiments, the environment data comprises future environment data for the plurality of environmental conditions. In further embodiments, the future environment data for each of the plurality of environmental conditions comprises an environment type at an environment location during an environment time, wherein the environment time comprises a future time. In further embodiments, the future environment data comprises a plurality of predicted environment types, each of the plurality of environment types corresponding to an environment location during a future environment time. In further embodiments, the future environment data is calculated using current environment data, historical environment data, or any combination thereof. In some embodiments, the environment type is selected from the group consisting of: traffic condition, weather condition, and road condition. In some embodiments, the environment data is obtained from one or more environmental data servers. In some embodiments, the event data comprises historical event data for the plurality of events. In some embodiments, the event data comprises current event data for the plurality of events. In some embodiments, the event data comprises future event data for the plurality of events. In further embodiments, the future event data for each of the plurality of events comprises an event type at an event location during an event time, wherein the event time comprises a future time. In further embodiments, the future event data comprises a plurality of predicted event types, each of the plurality of event types corresponding to an event location during a future event time. In further embodiments, the future event data is calculated using current event data, historical event data, or any combination thereof. In some embodiments, the event data is obtained from one or more event data servers. In some embodiments, the event type is selected from the group consisting of: concert, sporting event, political demonstration, festival, performance, riot, protest, parade, convention, and political campaign event. In some embodiments, the method comprises receiving, by the device, instructions to provide one or more risk predictions from an emergency management system or emergency dispatch center and sends the one or more risk predictions to the emergency management system or emergency dispatch center. In some embodiments, the emergency management system provides the data corresponding to a defined emergency, a defined geographic area, and a defined time period. In some embodiments, the method comprises providing, by the device, one or more risk predictions to one or more emergency management systems or emergency dispatch centers, wherein the risk predictions enhance allocation of emergency response resources in preparation for future emergency requests. In some embodiments, the method comprises providing, by the device, one or more risk predictions to an emergency management system or emergency dispatch center autonomously without requiring instructions requesting one or more risk predictions. In some embodiments, the prediction algorithm generates the prediction model using regression statistical analysis on the emergency data, environmental data, and event data, wherein the statistical analysis is selected from linear regression, logistic regression, polynomial regression, stepwise regression, ridge regression, lasso regression and ElasticNet regression. In some embodiments, the prediction algorithm comprises generating the prediction model using machine learning on the emergency data, environmental data, and event data, wherein the machine learning is selected from Support Vector Machine (SVM), Random Forest (RF), Naïve Bayes Classifier, neural networks, deep neural networks, and logistic regression.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings in FIGS. 1-11.

FIGS. 1A and 1B show schematics of one embodiment of the digital processing device and associated computer program.

FIG. 2 is an illustration of one embodiment of the emergency prediction system.

FIG. 3 is an illustration of how an emergency prediction system may use a prediction algorithm to calculate a risk prediction for emergencies and to send a warning or warning signal to communication devices to inform users about this risk.

FIG. 4 is an illustration of an embodiment of a prediction algorithm based on regression.

FIG. 5 is an illustration of an embodiment of a prediction algorithm based on a self-learning scheme.

FIG. 6 is a flow chart illustrating one example of a prediction algorithm for calculating risk prediction for emergencies and sending warnings for Thanksgiving day.

FIG. 7 depicts temperature a week before Thanksgiving for thirty counties in Massachusetts in 2015.

FIGS. 8A, 8B and 8C depict exemplary emergency data, specifically the call data, on a locational map.

FIGS. 9A, 9B, 9C and 9D are schematics of exemplary emergency and environmental data on a locational map.

FIG. 10 illustrates exemplary environmental and emergency data from time instances may be used to generate a risk probability map.

FIG. 11 shows a flow chart of a process for updating a prediction model for making risk predictions by an emergency prediction system (e.g. prediction server).

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

### Field of Invention

Aspects and embodiments disclosed herein are generally directed to systems and methods for the prediction of emergency situations and for communicating such predictions to emergency dispatch centers and/or mobile wireless devices.

### Certain Terminologies

As described herein, a “prediction system” or “emergency prediction system” refers to a system that applies a prediction algorithm to data (e.g., historical emergency, environmental, and event data) in order to generate a prediction model for making emergency predictions. A prediction system can be a prediction server, wherein the prediction server comprises a digital processing device comprising: at least one processor, an operating system configured to perform executable instructions, a memory, and a computer program including instructions executable by the digital processing device to create a server application.

As described herein, “municipalities” and “counties” refer to a local government or an administrative division of a state that will be responsible for providing dispatchers, first responders, or emergency response personnel during emergency situations. A “county” refers to a political and administrative division of a state in both urban and rural areas. In contrast, a “municipality” refers to a town or district that has local government particularly in population centers including incorporated cities, towns, villages and other types of municipalities. Depending on the location, emergency response for different types of emergencies may be provided by either the municipality or the county administration.

As described herein, “emergency service providers” may include organizations and institutions that may provide assistance in an emergency. For example, law enforcement, fire, emergency medical services commonly handle many emergency requests. In addition, specialized services may also be included, such as Coast Guard, Emergency management, HAZ-MAT, Emergency roadside assistance, animal control, poison control, social services, etc. Emergency service providers, emergency response personnel, emergency dispatch center, and public safety access points may be used to refer to the organizations, systems, and/or personnel that provide emergency response services and/or coordination of such services.

As referenced herein, an “Emergency Management System (“EMS”) refers to a system that receives and processes emergency alerts from subjects and forwards them to the EDC. Various embodiments of the EMS are described in U.S. patent application Ser. No. 14/856,818, and incorporated herein by reference. The “Emergency Dispatch Center (“EDC”) refers to the entity that receives the emergency alert and coordinates the emergency assistance. The EDC may be a public organization run by the municipality, county or city or may be a private organization. The emergency assistance may be in various forms including medical, caregivers, firefighting, police, military, paramilitary, border patrol, lifeguard, security services. Generally, the EDC and EMS are distinct entities. In some embodiments, the EDC may comprise an EMS.

As described herein, “geographic area,” “geographic location,” “area,” “location,” all refer to a geographic space that can range from an exact latitudinal and longitudinal coordinate to an area encompassing, for example, a city block, a neighborhood, a city, a county, a stretch of highway, a park, a recreation area, a sports stadium, a convention center, an area block (e.g. a 1×1 square mile area block), or other area. A “geographic area” may be used in the context of a “defined geographic area” corresponding to a risk prediction. A “location” may be used in the context of emergency location, environmental location, or event location corresponding to the location of said emergency, environmental condition, or event. A geographic area may comprise one or more locations. For example, a defined geographic area that is a county may comprise a plurality of neighborhood locations.

As described herein, “data” refers to electronic information. Data may comprise electronic information stored on a server. Data may comprise information obtained from communication devices such as, for example, a landline phone. Data may comprise information obtained from wireless mobile devices such as, for example, a smart phone. Data may comprise information stored in a database. Data may comprise information for environmental conditions (“environmental data”) such as, for example, precipitation level or temperature. Data may comprise information on events (“event data”) such as, for example, the date of a holiday. Data may comprise information on emergencies or emergency requests (“emergency data”) such as, for example, the number of emergency calls or requests. Data may comprise historical data comprising information on past environmental conditions, events, emergencies, or any combination thereof. For example, historical data may comprise the emergency type, emergency location, and emergency time of one or more emergencies that has already taken place, and not an ongoing emergency or a predicted future emergency. Historical data may be data that is at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 minutes old or more. Historical data may be data that is at least 1, 2, 3, 4, 5, 6, 7, 8, 9, 10, 11, 12, 13, 14, 15, 16, 17, 18, 19, 20, 21, 22, 23, 24 hours old or more. Historical data may be data that is at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 days old or more. Historical data may be data that is at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, or 52 weeks old or more. Data may comprise current data comprising information on current environmental conditions, events, emergencies, or any combination thereof. For example, current data may comprise the type, location, and time of a wildfire (environmental condition) at the present time based on the most recent information available (e.g. satellite imaging, live surveillance from news helicopters, etc). Current data may be data that is no more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes old. Current data may be data that is no more than 1, 2, 3, 4, 5, 6, 7, 8, 9, 10, 11, 12, 13, 14, 15, 16, 17, 18, 19, 20, 21, 22, 23, or 24 hours old. Current data may be data that is no more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 days old. Data may comprise future data comprising information on future environmental conditions, events, emergencies, or any combination thereof. Future data may be data on environmental conditions, events, or emergencies that have not yet occurred or are not yet in existence. For example, future data may comprise information on planned events such as a planned parade including the event type, event time (e.g. date, time of day, and/or duration), and event location. As another example, future data may comprise forecasted information on an environmental condition such as a tornado including the forecasted environment type, environment time, and environment location (e.g. tornado forecast for county A during 5-9 PM on this Friday).

As used herein, “variable” refers to a parameter used within a model. For example a linear regression model having a formula Y=C₀+C₁x₁+C₂x₂ has two predictor variables or parameters, x1 and x2, and coefficients for each parameter, C₁ and C₂ respectively. The predicted variable in this example is Y. Data may be entered for each predictor variable or parameter in a model to generate a result for the dependent or predicted variable (e.g. Y).

As used herein, “average” refers to a statistical measure of a plurality of values. Average may be selected from the group consisting of: mean, median, mode, and range.

As used herein, “risk” refers to the likelihood of occurrence of an emergency, emergency event, or emergency request. A “risk prediction” refers to the likelihood of occurrence of an emergency, emergency event, or emergency request corresponding to a defined emergency, a defined geographic area, and a defined time period that is generated by a prediction model described herein in the present disclosure. For example, a risk prediction for traffic accident emergencies (defined emergency) in county A (defined geographic area) during the time period of 12 PM-9 PM on a non-holiday weekday (defined time period) may be about 24 emergency requests (risk prediction). A risk prediction is calculated using a prediction model generated by an algorithm. The algorithm may statistical tools/methods to compare historical data for emergencies with historical data on environmental conditions and events in order to generate a prediction model that correlates the relationship between environmental conditions and/or events with the number of emergencies. The algorithm may also comprise machine learning methods in generating the prediction model. A prediction model can be a formula comprising parameters that determine the likelihood of a defined emergency. For example, a prediction model can be a multiple linear regression model or formula that generates a risk prediction for the total number of all emergency calls within the city limits of city B for next Friday when data corresponding to environmental condition(s) (e.g. expected rainfall) and/or event(s) (e.g. grand opening of a museum downtown) inside city B next Friday is entered into the model. A prediction model can be a classifier or trained algorithm generated by the application of a machine learning algorithm to a data set comprising emergency, environmental, and event data.

As used herein, “actual risk” refers to the actual occurrence of one or more emergencies corresponding to a defined emergency, a defined geographic area, and a defined time period. For example, a risk prediction for the number of car accidents in county C during the first week of January may be 85 emergency calls or requests, while the actual risk based on information collected during this period may be 46 emergency calls or requests. The difference or ratio between a risk prediction and its corresponding actual risk may be used to calculate an accuracy score for the risk prediction. The accuracy of a prediction model may also be assessed by calculating fit error through comparing the risk prediction with the actual risk (e.g. actual emergency data).

As used herein, “warning” or “warning signal” refers to a message containing information of one or more risks or emergency situations and may be used interchangeably. The warning or warning signal may comprise additional information, such as, for example, advice for escaping, resolving, mitigating, or reducing the likelihood of occurrence of the risk or emergency situation.

### Emergency Prediction

The systems, methods, and media provided in the present disclosure as described herein allow for the application of an algorithm towards emergency, environmental condition, and event data to generate a prediction model for making risk predictions for a defined emergency, a defined geographic area, and a defined time period. This enables emergency response organizations, systems, and personnel to obtain predictions of future emergency events to optimize resource allocation as a pre-emptive measure for improving emergency responses. Moreover, warnings can be sent to the communication devices of subjects with risk predictions of elevated risk such, as for example, people in the path of a severe thunderstorm (e.g. determined using subject data comprising location information obtained from subject communication device) as a preventative measure. Individuals, both civilians and emergency response personnel, may also communicate with the emergency prediction system to obtain relevant risk predictions, such as for example, an elevated risk of traffic accidents in a nearby geographic area. Civilians may use this information to avoid the area of elevated risk, while emergency response personnel may choose to approach or enter the area in preparation for possible emergency events.

Environmental conditions such as weather may have an impact on the number of emergencies within the geographic area during a specific time period. Likewise, events such as a sports game may also have an effect. Weather conditions such as air temperature, wind speed, precipitation, fog, pavement temperature and condition, water level, and other conditions may impact emergencies such as traffic accidents. In addition, various non-environmental events may have an impact on the number of emergencies. For example, Thanksgiving week is one of the deadliest weeks of the year due to the spike in traffic accidents. Various factors may be responsible for large number of car crashes during the week of Thanksgiving including the increased number of vehicles on the roads, drivers navigating unfamiliar roads, driving in the evening and/or under the influence. In addition to traffic accidents, there are many medical emergencies associated with Thanksgiving including knife wounds, burns, food poisoning, overconsumption, and more. Other events like football games, baseball games, basketball games, concerts and festivals can also be associated with increase in certain types of emergencies. For example, sports events such as baseball games are associated with emergency rooms filling up with cases of alcohol poisoning, bodily trauma, chest or stomach pain. The systems, methods, and media provided in the present disclosure as described herein organize and process this emergency, environmental, and event data to generate prediction models that quantify this relationship between emergencies and environmental conditions and events in order to generate risk predictions.

The systems, methods, and media described herein would not have been possible in the pre-digital, pre-Internet age when data systems could not have been consolidated, networked, or connected in a dynamic fashion to enable an emergency prediction system to obtain data, generate prediction models, and provide risk predictions efficiently, and on demand. Moreover, the technologies described herein rely upon recent improvements in collection and reporting of emergency event or incident information and improvements in prediction of environmental conditions, such as weather forecasts. Finally, it has not been possible to gain knowledge of the exact geo-location and type of the emergency events in a given geographic region in real-time. As a result, emergency dispatch centers (EDCs), such as public safety access points (PSAPs), have historically been unable to reliably obtain accurate information on past emergency events and related environmental conditions and/or events to predict the occurrence of future emergency events based on current or forecasted information. Accordingly, an EDC, such as a PSAP, was incapable of delivering a warning to subjects within a certain geographic area regarding increased possibility of certain type of emergency situations because it lacked both the capacity to make accurate predictions and the ability to deliver such predictions to relevant subjects. EDCs have been even further limited in the ability to provide such warnings in real-time. Therefore, the general public has not been able to benefit from enhanced emergency response and/or targeted warnings that allow adjustment of behavior to reduce exposure to elevated risks of emergencies. Thus, the technologies described herein provide a technological improvement to a technical field that heretofore did not exist in the analog world aside from crude analog forecasts based on human discretion and instinct.

Existing prediction models, such as numerical or probabilistic weather forecasting, are able to predict environmental variables, such as weather, to a reasonable accuracy, especially within a 24-48 hour time window. Schedules or other knowledge of upcoming public and community events in a given geographic area in most municipalities are typically available. The methods of the present disclosure take advantage of such information by applying an algorithm to the information to build one or more prediction models and for entering relevant data (model parameters) into the models to generate risk predictions. An algorithm may analyze the type, location, and time data for historical emergencies, environmental conditions, and events to build a prediction model of future emergency situations. For example, emergencies due to loss of electricity in a particular county may be positively correlated with heat waves (e.g. increased use of air conditioning can heighten demand on the electrical grid and lead to rolling blackouts) and thunderstorms (e.g. storm activity knocking down electric poles), and a prediction model will account for these relationships. Following creation of the prediction model, knowledge of upcoming public events in a geographic area (future event data) and/or environmental conditions (future environmental data such as, for example, weather forecasts) can be entered into the prediction model to generate one or more risk predictions. Future data may be obtained from publicly accessible servers or databases, private servers or databases, the emergency management system itself, the communication devices of subjects, other sources of such information, or any combination thereof.

In some embodiments, the systems, methods, and media described herein allow for the creation of a risk prediction model for generating one or more risk predictions. A risk prediction may correspond to a defined emergency, a defined geographic area, and a defined time period. A defined emergency may comprise an emergency type, such as for example, traffic accident or heat stroke/exhaustion. The emergency type can be selected from vehicle/traffic emergency, fire emergency, police emergency, medical emergency, or any combination thereof. Emergency types are described in greater detail in the “Emergency Data” section.

A defined geographic area may comprise a city block, a neighborhood, a city, a county, a stretch of highway, a park, a recreation area, a sports stadium, a convention center, an area block, or other geographic area. A geographic area may be divided into a locational grid (“grid”) comprising a plurality of area blocks. A defined geographic area may comprise one or more area blocks. An area block can be a square, a rectangle, a diamond, a hexagon, or some other geometric shape. The area blocks inside a grid may be of equal shape. The area blocks inside a grid may be of unequal shape. The area blocks inside a grid may be of equal size. The area blocks inside a grid may be of unequal size. An area block may comprise less than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 square miles. An area block may comprise more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 square miles. An area block may comprise less than about 10×10, 20×20, 30×30, 40×40, 50×50, 60×60, 70×70, 80×80, 90×90, 100×100, 200×200, 300×300, 400×400, 500×500, 600×600, 700×700, 800×800, 900×900, or 1000×1000 m². An area block may comprise more than about 10×10, 20×20, 30×30, 40×40, 50×50, 60×60, 70×70, 80×80, 90×90, 100×100, 200×200, 300×300, 400×400, 500×500, 600×600, 700×700, 800×800, 900×900, or 1000×1000 m² or more.

A defined time period may be a time of the day, a day of the week, a day of the month, a holiday, a duration of an environmental event (e.g. blizzard). A defined time period may be regularly occurring, such as for example, a holiday that occurs once a year. A regularly occurring defined time period may be a certain time of the day, such as for example, between 5 PM and 7 PM during weekdays corresponding to rush hour. In some embodiments, a defined time period comprises at least one time block, wherein a 24 hour time period is divided into a plurality of time blocks. The plurality of time blocks may comprise time blocks of equal length. Alternatively, the plurality of time blocks may comprise time blocks of unequal length. A time block may be about 1, 2, 3, 4, 5, 6, 7, 8, 9, 10, 11, 12, 13, 14, 15, 16, 17, 18, 19, 20, 21, 22, 23, or 24 hours. A time block may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes. A time block may be a specific subset of a 24 hour time period. For example, a time block may be between 12-1 AM, 1-2 AM, 2-3 AM, 3-4 AM, 4-5 AM, 5-6 AM, 6-7 AM, 7-8 AM, 8-9 AM, 9-10 AM, 10-11 AM, 11 AM-12 PM, 12-1 PM, 1-2 PM, 2-3 PM, 3-4 PM, 4-5 PM, 5-6 PM, 6-7 PM, 7-8 PM, 8-9 PM, 9-10 PM, 10-11 PM, or 11 PM-12 AM. In some embodiments, a defined time period comprises a time of year. A defined time period may comprise a season selected from summer, fall, winter, spring, or any combination thereof. A defined time period may comprise one or more days in the week. A defined time period may comprise or more days in the week selected from Monday, Tuesday, Wednesday, Thursday, Friday, or any combination thereof. A defined time period may comprise one or more days in the weekend. A defined time period may comprise one or more days in the weekend selected from Saturday, Sunday, or any combination thereof. A defined time period may comprise one or more months of the year. A defined time period may comprise one or more months of the year selected from January, February, March, April, May, June, July, August, September, October, November, December, or any combination thereof. A defined time period may comprise one or more weeks of the year. A defined time period may comprise one or more weeks of the year selected from week 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, or any combination thereof. As an illustrative example of the possible variations for a defined time period, a defined time period may comprise non-holiday Fridays in January and February between 5 PM and 7 PM.

The emergency type, geographic area, and time period may be defined in one or more ways. A subject may directly access an emergency prediction system, platform, or media to request a risk prediction by providing a defined emergency, a defined geographic area, and a defined time period. A subject may be a passenger in a motor vehicle on the freeway wishing to know the risk prediction for an accident for the next 50 mile stretch of freeway. A subject may be an emergency management system, public safety answering point, emergency dispatch center, or any other emergency response personnel requesting one or more risk predictions. The defined emergency, defined geographic area, and defined time period may be pre-defined in the system for automatic generation of one or more risk predictions. For example, an emergency management system administrator (“admin”) for a particular county may wish to obtain daily risk predictions for each area block of the county (which has been divided into a grid of 5 square mile area blocks) for all traffic and fire related emergencies.

The systems, methods, and media described herein may be customized by an admin, a user, an EMS, or an EDC to automatically provide the risk predictions on a daily basis at a regular time. The systems, methods, and media described herein may also be customized to provide automatic warnings specific to one or more subjects (based on subject data) who are not associated with the emergency response systems or personnel. For example, a subject may be driving on the highway and is approaching a dangerous section of the road with a blind corner. The prediction model created using historical emergency data generates a prediction that this location (e.g. stretch of highway or area block comprising this stretch of highway) is likely to have a 10-fold higher risk of traffic accidents compared to a baseline risk for the average stretch of highway in the county during peak traffic hours of 5-7 PM. The prediction system compares the risk prediction to a defined risk threshold of 5-fold higher risk set by a system administrator. Because the predicted 10-fold higher risk exceeds the defined risk threshold, the emergency prediction system is authorized to send a warning to any subjects who fall within the risk prediction's defined geographic area and defined time period (“zone of danger”). The emergency prediction system obtains subject data from the subject's communication device including location data showing the subject's location on the highway and that the subject is approaching the section with elevated risk. The emergency prediction system calculates the subject's location will be within the defined geographic area (dangerous stretch of highway) during the defined time period (between 5-7 PM) in the next 15 minutes at 6:20 PM (future data comprising future location and future time). Alternatively, the subject's communication device may provide the subject's future location and future time to the emergency prediction system. The emergency prediction system may then automatically send a warning to the subject's communication device comprising the risk prediction showing elevated risk of a traffic accident. The warning may include the estimated time of arrival (ETA) for the subject entering the defined geographic area during the defined time period that puts the subject at the 10-fold elevated risk for a traffic accident indicated by the risk prediction. The warning may comprise a suggested alternate route to avoid the dangerous stretch of highway.

An emergency prediction system may obtain subject data from one or more subject communication devices actively upon subject interaction or direction, for example, wherein the subject interacts with a phone application to send subject data to the emergency prediction system. An emergency prediction system may obtain subject passively without user interaction, for example, wherein the subject has enabled the subject communication device to send subject data such as location information periodically or on request by the emergency prediction system. Subject data obtained from a subject communication device may be stored within the data module of an emergency prediction system. Subject data may be stored within a server or database of an EMS, a mobile phone company server, or other data repository that is accessible by an emergency prediction system.

The systems, methods, and media of the present disclosure can enable an EMS or EDC to issue warnings of elevated risk for specified emergencies based on risk predictions. The warnings may be sent specifically to subjects or individuals who are within the scope of the risk prediction (e.g. located within the defined geographic area during the defined time period). Warnings may be sent to the communication devices of one or more subjects with the goal of providing pre-emptive warning to minimize any potential injury or damage that may be caused by predicted emergency situations, and/or potentially prevent these situations from occurring at all. Warnings may be sent automatically whenever a risk prediction exceeds a defined risk threshold. Warnings may be sent automatically whenever a risk prediction exceeds a defined risk threshold by a minimum percentage. A minimum percentage may be 10%, 15%, 20%, 25%, 30%, 35%, 40%, 45%, 50%, 60%, 70%, 80%, 90%, 100%, 150%, 200%, 250%, 300%, 350%, 400%, 450%, 500%, 600%, 700%, 800%, 900%, or 1000% or more. A defined risk threshold may comprise an arbitrary value set by an administrator, user, EMC, EDC, or subject. A defined risk threshold may comprise an average of a plurality of risk predictions corresponding to the defined geographic location. A defined risk threshold may comprise an average of a plurality of risk predictions corresponding to a plurality of defined geographic locations

The warning may be based on a prediction model built using data comprising emergency data, environmental condition data, and event data. Emergency data can include information on past requests for emergency assistance received from communication devices such as, for example, the geographic location of the device sending the request for assistance, the time when the request was sent, the type of emergency prompting the emergency request, or any combination thereof. The warning may comprise the defined emergency. The warning may comprise the defined geographic area. The warning may comprise the defined time period.

The warning may contain information regarding an increased probability of certain types of emergencies, their possible time duration and geographic region of impact and possible methods for a subject to whom the warning is sent to mitigate impact of emergency situations. The warning may be non-specific to any one subject, but sent to particular subject communication devices based on the location of the communication devices at the time of a predicted increase in probability of an emergency occurring at or proximate the location of the subject communication devices.

In some embodiments, the warning may communicate information about changes in traffic pattern on certain highways or roadways in a specific geographic location and may further communicate suggestions for alternate routes to a subject through the communication device. Switching to one of the suggested alternate routes may reduce the probability of a traffic based delay or other traffic-based incident for the subject.

In some embodiments, the warning may contain information about weather-based events (e.g., heavy rain, thunderstorms, and snowstorms, and may further contain information about the impact of the weather based event on the probability of the occurrence of one or more emergency situations). Predictions regarding the impact of the weather-based event on the probability of the occurrence of the one or more emergency situations may be based on a predictive model built from information provided to the prediction server about weather-based events (e.g., heavy rain, thunderstorms, and snowstorms) in a geographic area, and information regarding the history of requests for emergency assistance placed from the same geographic area at the times of the weather-based events.

In some embodiments a prediction model for predicting the probability of occurrence of emergency situations may be based, at least in part, on information provided to the prediction server about public events, for example, baseball games, basketball games, music concerts, and/or other public events in which a substantial number of people are simultaneously hosted in one particular geographic location, and information regarding a history of requests for emergency assistance placed from the same geographic area as the public events, during, before, or after occurrence of the public events. A warning may be sent to subjects in a geographic location proximate a type of public event responsive to the prediction model indicating an increased probability of an emergency event occurring in the geographic location and resulting from or correlated with occurrences of the type of public event.

In the prediction server periodically receives information updates from one or more subject communication devices regarding a specific emergency situation. The prediction server may incorporate information from the updates from communication devices into an emergency prediction model, and make a decision regarding whether there has been a change in the probability of occurrence of any specific type of emergency situation, either since the last warning message received at the subject communication device, since initiation of warnings from the prediction server to subject communication devices in a given geographic area, since the last update received at the prediction server from the subject communication device, or since any such time communication was established between subject communication device and EDC. The information update from the user may now allow the prediction server to generate a risk prediction indicating a lower risk. For example, a user on a dangerous stretch of highway may have taken an exit off the highway, and the updated GPS location information sent by the user's communication device to the EDC may enable the information to be used by a prediction server to calculate a new risk prediction based on the user's current location. The prediction server may calculate a new risk prediction (e.g. one that shows a lower risk compared to the earlier risk prediction) and communicate a warning including an indication of the change in the probability of occurrence of the emergency situation to the communication device that sent the periodic update. In some embodiments, the prediction server may communicate the same warning to the communication devices of the other subjects in the proximate geographic area that may be at risk.

In some embodiments, the updates received from communication device may pertain to traffic pattern changes, such as road blockages, delays, availability of certain lanes on certain highways, congestion levels on certain exits where the subject communication device may be located, and other such information pertaining to traffic patterns, on certain highways and roadways in a certain geographic location.

In some embodiments, the updates received from the communication device may pertain to weather-based events, for example, an amount of rain received in a certain geographic area, observance of thunderstorms in a given geographic area, or observance of inclement weather such as snow storms or other extreme weather conditions, and incidents that may be related directly or indirectly to the weather-based event, for example, traffic accidents, pedestrian incidents, difficulty in driving a motor vehicle on certain highways, or interruption in municipal facilities such as water supply, electricity supply, garbage collection or other such municipal services in the certain geographic area.

In some embodiments, updates received from the communication device at the prediction server may pertain to public events, for example, a sporting event (e.g., a baseball game, basketball game, football game, etc.) held at a public location or venue such as a university stadium or a stadium managed by the city, or any other public event. These updates may contain information about the event, for example, direction of flow of the people within the venue, whether certain exits of a building housing the event are congested and/or the amount of congestion at these exits and if this congestion is resulting in reduction of the ability of people to move freely through these exits, whether certain motor vehicle parking areas are congested and/or the level of congestion and if this congestion is resulting in a reduction in the ability of motor vehicle drivers to drive the motor vehicle out of the parking area, and other such conditions pertaining to the inability of people to move in and around the venue.

In some embodiments, the updates received from the communication device at the prediction server are generated by interaction of the subject with the communication device, for example, by touching a touch screen, pressing of soft or hard buttons by the subject, by voice input from the subject to the communication device and other such input provided by the subject to the communication device.

In some embodiments, the updates received from the communication device at the prediction server are generated autonomously by the communication device without any input from the subject. Such autonomous updates may include, for example, periodic location updates or information regarding the availability of other communication devices in the vicinity of a particular communication device.

Aspects and embodiments disclosed herein provide for methods and systems for transmission of emergency warnings or messages from a prediction server based on information about possible adverse environmental conditions. The risk or probability of occurrence of one or more emergency situations correlated with the environmental conditions may be calculated in the prediction server and warnings and messages may be sent to subjects on their mobile wireless devices.

Also disclosed herein are methods for selecting mobile wireless devices based on their geographic locations, demographic information, prior incidents, subject preferences, etc. Also disclosed herein are aspects and embodiments of a method of reporting from a communication device to a prediction server real-time information about the environment of the communication device and any other input provided by the subject, wherein the prediction server may use the reported information to update warnings to subjects in the same or proximate geographical location.

Existing filings, for example, PCT application No. PCT/US2015/050609, titled METHOD AND SYSTEM FOR EMERGENCY CALL MANAGEMENT, disclose systems and methods that take advantage of Voice over Internet Protocol (VoIP) technology to make emergency calls to EDCs that include indications of the exact geographic locations of subject communication devices used to place the emergency calls. Such systems may allow an EDC or EMS to build a geographically sensitive history of emergency calls or requests for a given administrative area or municipality.

The systems, methods, and media of the present disclosure include approaches for providing real-time indications of changing risk or probabilities of the occurrence of various types of emergency situations in defined geographic locations to subjects through communication devices such as wireless mobile devices via text or multimedia messages.

In accordance with one aspect, there is provided a method for communicating a warning to communication devices over data communication channels, for example, the Internet. The warning may be sent from a prediction server. The prediction server may be housed at an EDC such as a PSAP, in an emergency messaging system (EMS), in a convenient location in the Internet, or in a given administrative area or municipality. The warning may be based on a prediction model built using data comprising emergency data, environmental condition data, and event data.

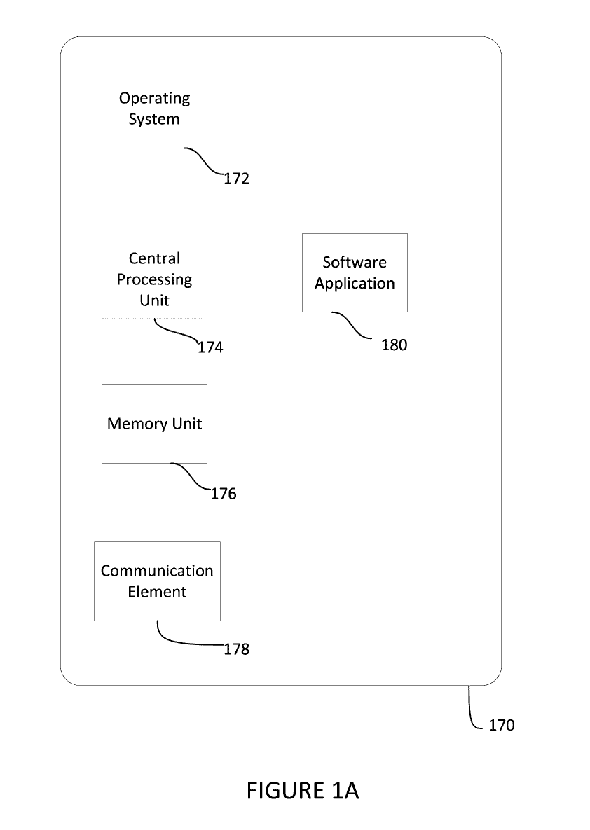

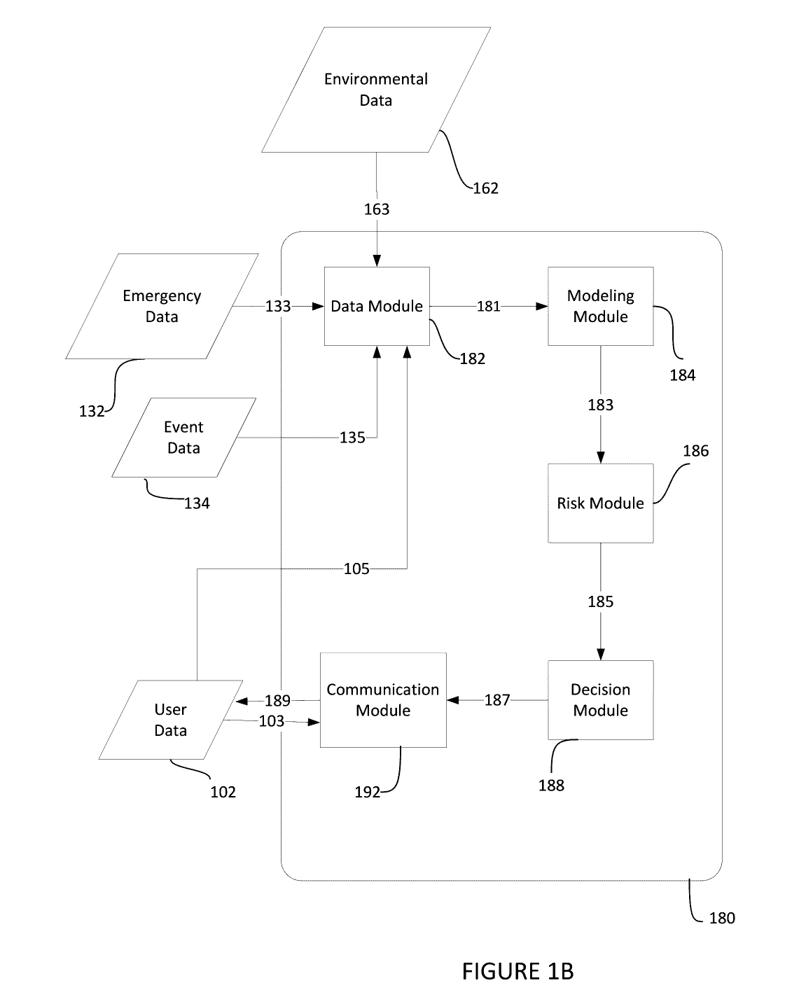

FIG. 1A is a schematic of one embodiment of the emergency prediction system or prediction server 170. The prediction server may comprise one or more computers that provide a prediction service for a system such as the EMS or a group of subjects. In some embodiments, the prediction server 170 may comprise one or more servers that are part of the EMS. In other embodiments, the prediction server 170 is a separate server from the EMS, as shown. In some embodiments, the prediction server 170 is hosted on the Internet or part of a network.

The prediction server 170 may be one or a group of computers. Each server computer may include several components such as at least one central processing unit or processor (CPU) 174, an operating system 172 configured to perform executable instructions, a memory unit 176, a network or communication element 178 (e.g., an antenna and associated components, Wi-Fi, Bluetooth®, etc.) and a computer program including instructions executable by the digital processing device or a software application 180 for applying a prediction algorithm to emergency, environmental, and event data to create a prediction model for generating one or more risk predictions.

In some embodiments, the prediction server 170 may be run on one or more desktops that were converted into a server by running a server operating system 172. In other embodiments, the server computers are dedicated machines engineered to manage, store, send and process data 24-hours a day. In some embodiments, the server computers may be located in the same geographical location. In other embodiments, the server computers may be distributed in various geographical locations.

In some embodiments, the prediction server 170 includes an interface and display (not shown) through which one or more administrators of the prediction server 170 can give instructions and access results. To gain access to the server operating system 172, an administrator's log-in and password may be required. In some embodiments, the algorithm may allow the administrator to provide input at various points in the algorithm such as in filtering and processing of the input data (including data cut), choice of the type of statistical model, method, or analysis (e.g. regression, machine learning, etc.) to implement, selection of an event of interest, choice of databases to connect to for environmental, emergency or event data, predictor variable selection, predictor variable elimination, removal of outliers, etc.

In some embodiments, an administrator may provide input to the risk module in order to obtain one or more risk predictions from a risk model. The risk module may obtain input and use it to enter data into the risk model to generate risk predictions. An administrator may provide input by defining the emergency type, the geographic area, and the time period for the generation of a risk prediction. The risk module may obtain data corresponding to the defined emergency type, the defined geographic area, and the defined time period from the data module such as, for example, future data comprising future environmental data corresponding to the defined geographic location at the defined time period. The risk module may enter the data corresponding to the defined emergency type, the defined geographic area, and the defined time period into the risk model to generate one or more risk predictions.

An interface (e.g. user interface) may display a locational map with graphical representations of emergency data, environmental data, and event data. The map may comprise a grid comprising a plurality of area blocks. The map may also comprise graphical representations of one or more subjects at their current, historical, or future locations amongst the plurality of area blocks. The map may comprise graphical representations of risk predictions for defined geographic areas within the map during a defined time period. Each risk prediction may be for a defined emergency comprising one emergency type or a plurality of emergency types. The map may comprise graphical representations of emergency response personnel at their current, historical, or future locations. The graphical representations may be interactive to allow a user or administrator to manipulate the graphical representations by moving them around. For example, the graphical representations of emergency response personnel may be moved around the map as the user or administrator decides where to position or station the personnel based on the risk predictions.

FIG. 1B shows a schematic of one embodiment of the software application 180 on the prediction server 170 (see FIG. 1A). The software application 180 may comprise one or more modules, which may or may not be separable within the application or the list of instructions. The software application 180 may include one or more modules including a data module 182 for obtaining different types of data from various sources for generating the risk prediction. For example, the data module 182 may obtain emergency data, environmental data, event data and subject data. In addition, the data module 182 may filter and process the data. In some embodiments, an administrator of the server 170 may choose a particular a subset of data or a specific time window for the data. In some embodiments, the data module 182 may store the data in searchable form or in a form that can be used for inputting into the modeling module 184.

In addition, the software application 180 may include other modules including the modeling module 184 for applying a prediction algorithm 194 (not shown) to the emergency data, environmental data, and event data to create at least one prediction model. The risk module 186 may generate a risk prediction 198 (not shown) by applying the prediction model 190 (not shown) to current or forecast data 196 (not shown) corresponding to a defined emergency within a defined geographic area and defined time period. The decision module 188 may make a decision regarding whether risk prediction for the defined emergency is high or elevated and whether warning signals or messages should be sent to recipients, such as subjects or emergency service providers. In some embodiments, the communication module carries out any combination of the functions of the decision module.

If the decision is made to send warning signals or messages to subjects through their communication devices, the communication module 192 may send them to subjects on their communication devices through a data communication link 189. In some embodiments, subject data 102 from the communication devices including locational information (e.g., GPS information) and information about the speed and direction of travel may be used by the communication module (via 103) to choose which devices to send the warning signals and messages.

In one embodiment, subject data 102 may be obtained by the data module 105 for processing and storing for modeling (via 105). Subject data about the location and trajectory of subjects (based on information from their communication devices) may provide one or more independent variables for the risk prediction. For example, the locational density of subjects in or near a sports stadium may be predictive of the risk of emergencies. As another example, the location and direction of subjects on a highway may be predictive of emergencies on the road. In this way, one or more risk predictions may be generated on a real-time basis for risks that are ongoing or imminent.

In some embodiments, environmental, emergency and event data may be updated based on subject data. For example, subject's communication devices could update the prediction server with information about current temperature, visibility conditions, traffic conditions, emergencies on the road, smoke or fire, etc. In addition, subjects could use their communication devices send information or data updates to the prediction server concerning environmental, emergency and event data. In other embodiments, the emergency service providers may provide information about emergency resources and personnel to get recommendations on allocation of resources and personnel from the EMS.

The software application 180 may be in any computer programming languages such as Perl, PHP, Python, Ruby, JavaScript (Node), Scala, Java, Go, ASP.NET, ColdFusion, etc. In some embodiments, the software application 180 may have one or more interfaces such as Server Application Programming Interface (SAPI), GUI or any other interface.

### Data Module

The data module 182 is a component of the software application 180, which receives data from various sources including the EIS, EMS and other public and private databases or sources. The raw data may be filtered and processed and converted into a format suitable for inputting into the prediction algorithm 194.

The data module may contain data in a spreadsheet or database with each entry associated with a particular date and time and various columns for environmental, emergency and event data. Exemplary data that may be used in the prediction model is shown in Table 1.

### Modeling Module

The modeling module 184 is a component of the software application 180, which applies a prediction algorithm 194 (not shown) to the emergency data, environmental data, and event data to create at least one prediction model. The modeling module 184 may use any known mathematical relationships including linear regression, logistic regression, polynomial regression, stepwise regression, ridge regression, lasso regression and ElasticNet regression may be used. A prediction algorithm may comprise generating a prediction model using regression statistical analysis on the emergency data, environmental data, and event data, wherein the statistical analysis is selected from linear regression, logistic regression, polynomial regression, stepwise regression, ridge regression, lasso regression and ElasticNet regression. In other embodiments, gradient descent may be used instead of regression.

In some embodiments, the modeling module 184 may use machine learning principles including Support Vector Machine (SVM), Random Forest (RF), Naïve Bayes Classifier, neural networks, deep neural networks, logistic regression, etc., for classification. A prediction algorithm may comprise generating a prediction model using machine learning on emergency data, environmental data, and event data, wherein the machine learning is selected from Support Vector Machine (SVM), Random Forest (RF), Naïve Bayes Classifier, neural networks, deep neural networks, and logistic regression. Classification classes may include “Elevated risk”, “High risk”, “Excessive risk”, “Moderate risk”, “Low risk”, etc. In other embodiments, machine learning regression may be used to calculate emergency data or number of emergency calls using known methods such as support vector regression, Gaussian process regression, neural networks for regression, etc.

### Risk Module

The risk module 186 is a component of the software application 180, which may generate a risk prediction 198 (not shown) by applying the at least one prediction model 190 (not shown) to data corresponding to a defined emergency, a defined geographic area, and a defined time period, specifically to current or forecast data 196 (not shown). The risk module 186 may apply the prediction model (e.g., models based on regression or machine learning) to current data or forecast data associated with the event data (including an event of interest).

In some embodiments, the risk prediction may be in the form of expected number of emergency calls, density of emergency calls, emergency call volume, emergency risk, etc. In some embodiments, the risk prediction may be in the form of risk categories or probability of number of emergency calls, probability of emergency risks, etc.

### Decision Module

The decision module 188 is a component of the software application 180, which may determine the risk prediction for the defined emergency is elevated or high. In some embodiments, the decision module 188 may decide whether warning signals or messages should be sent to recipients, such as subjects or emergency service providers.

The administrator(s) of the prediction server define any criteria or algorithm for the decision module 188 including use of thresholds, cutoffs, relative risks, normalized risks, etc. The decision module 188 may be capable to incorporate administrator(s) input in the decision-making.

In some embodiments, the decision module 188 and the communication module 192 may be housed within in the prediction server, as shown. In some embodiments, the decision module 188 and the communication module 192 may be separate from the prediction. In some embodiments, the decision module 188 and the communication module 192 may be a part of the EMS.

### Communication Module

The communication module 192 is a component of the software application 180 utilized by an emergency prediction system or prediction server 170, wherein the server uses the communication module may be able to send and receive communication from various recipients and senders including one or more subjects and emergency service providers. The communication 192 may send and receive warnings or messages through the communication element 178 (e.g., an antenna and associated components, Wi-Fi, Bluetooth®, etc.) (see FIG. 1A).

In some embodiments, the communication module 192 may be housed in the prediction server. In some embodiments, the communication module 192 may be housed in the EMS or another server. Although not shown, the communication module 192 may not be involved only in sending warning signals and messages. In some embodiments, the communication module 192 may complete other tasks as needed.

### Emergency Data

Emergency data refers to information about emergencies that have occurred and may include the type of emergency (such as medical, fire, police or car crashes), the location of the emergency (e.g., GPS coordinates, altitude, etc.), the time of the emergency (e.g., date and time). Additional information regarding the emergency could also be obtained including, but not limited to, fatalities, types of injuries, proximity to landmarks (such as sports stadiums), signal strength for emergency call, whether the subject was in a vehicle during the emergency, information about road conditions, number and effectiveness of emergency service providers involved, time for emergency response, etc. Emergency data may comprise historical data or current data.

The emergency type can be selected from vehicle/traffic emergency, fire emergency, police emergency, medical emergency, or any combination thereof. A vehicle emergency can be a flat tire, collision with another vehicle, collision with a wall or artificial barrier, collision with a tree or natural barrier, collision with a pedestrian, collision with a cyclist, collision with a motorcyclist, collision with a wild animal, collision with a domesticated animal, collision with a pet, rollover, or running off the road. A medical emergency can be a heart attack, cardiac arrest, stroke, seizure, anaphylactic shock, electrical shock, cut, abrasion, contusion, stab wound, gunshot wound, broken bone, poisoning, burn, bug bite or sting, snake bite, animal attack, concussion, dismemberment, drowning, death, or any combination thereof. A police emergency type can be robbery, armed robbery, attempted robbery, home invasion, battery, rape, arson, kidnapping, shooting, terrorist attack, or any combination thereof. A fire emergency type can be a home fire, building fire, wildfire, chemical spill, explosion, electrical fire, chemical fire, combustible metal fire, flammable liquids fire, solid combustibles fire, or any combination thereof.

In some cases, the emergency data comprises an emergency call log with basic information such as a timestamp, GPS coordinates, and type of emergency (e.g. as indicated by the subject). In other embodiments, the emergency data is the content of multi-media alerts sent by the subjects to the EMS within a time period. In some embodiments, the emergency data is the content of the emergency session with the EDC including details regarding the emergency.

The emergency data may be sourced from one or more EMS that may receive emergency calls. In some embodiments, the EMS may serve as a conference bridge for emergency alerts and calls from subjects. In addition, the emergency data may be obtained from publicly available data about emergencies.

### Environmental Data

Environmental data comprises information about one or more environmental conditions. For example, environmental conditions include temperature, precipitation (e.g. snow, hail, rain, sleet, etc.), thunderstorms, pressure, wind speed and/or direction, cloud conditions, extreme weather (such as tornadoes, high winds, hurricanes, frigid conditions etc.), earthquakes, wildfires, and more. In some embodiments, the environmental data comprises road conditions (such as pavement temperature, black ice on bridges, road grip, curvature, obstructions, etc.) and traffic data (such as traffic density, direction of traffic, accidents, etc). In some embodiments, environmental data may be stratified into two or more categories. For example, temperature may be stratified into cold, warm, and hot categories. A cold temperature category may be less than about 25, 24, 23, 22, 21, 20, 19, 18, 17, 16, 15, 14, 13, 12, 11, 10, 9, 8, 7, 6, 5, 4, 3, 2, 1, 0, −1, −2, −3, −4, −5, −6, −7, −8, −9, −10, −11, −12, −13, −14, −15, −16, −17, −18, −19, −20, −21, −22, −23, −24, or −25 degrees Celsius or lower. A warm temperature category may be between about 10-15, 15-20, 20-25, 25-30, 30-35 degrees Celsius, or any combination thereof. A hot temperature category may be than about 20, 21, 22, 23, 24, 25, 26, 27, 28, 29, 30, 31, 32, 33, 45, 35, 36, 37, 38, 39, 40, 41, 42, 43, 44, or 45 degrees Celsius or higher.

Environmental data may be stratified into two categories indicating the presence or absence of an environmental condition. For example, temperature may be stratified into freezing and non-freezing temperature categories with freezing temperatures comprising temperatures at or below zero degrees Celsius, and non-freezing temperatures comprising temperatures above zero degrees Celsius. In some embodiments, the presence or absence of freezing temperatures may be assigned arbitrary numerical values depending on the statistical analyses used to generate the prediction model. For example, a multiple linear regression model may comprise a multi-parameter formula with each parameter having a corresponding coefficient. The larger the coefficient, the greater the impact that parameter will have on the resulting emergency prediction. In this example, if freezing temperatures positively correlate with increased incidence of traffic accidents while non-freezing temperatures have no correlation, then the presence of freezing temperatures may be assigned a value of 1 while the absence of freezing temperatures may be assigned a value of 0. These values may be entered into a freezing temperature parameter in a multiple linear regression formula (prediction model) in which the presence of a freezing temperature (1) enables the formula to calculate an increased risk of traffic accidents. Conversely, entry of the absence of a freezing temperature (0) would reduce the combined freezing temperature parameter and its coefficient value to zero.

The environmental data may comprise environment type, environment location, and environment time for one or more environmental conditions. In some embodiments, the systems, methods, and media described herein process the environmental data to obtain data pertaining to environment type, environment location, and environment time. In some embodiments, environmental data values are estimated based on available information to input into the algorithm if some of the environmental data needed for the model is not available.

The environmental data may be sourced from one or more publicly accessible or private servers or databases. For example, climate data online may be accessed from National Centers for Environmental Information for global historical weather or climate data within specific a time period.

### Event Data

Event data refers to information on one or more public or private events or holidays such as Thanksgiving or Christmas. Event data may comprise information on event type, event location, and event time for one or more events. In some embodiments, event data may include information on a variety of event types such as, for example, festivals, concerts, public gatherings, sports events or games, conferences, workshops, conventions, and other events. Sports events may be amateur or professional events. In some embodiments, the event is a recurring event such as, for example, Thanksgiving, Halloween, or the day of the week (e.g., Monday). Holidays may include national holidays. Holidays may include state holidays, such as for example, Alaska Day on October 18. Holidays may include local holidays. Holidays may include non-public holidays, such as for example, Hanukkah or Ramadan. Holidays may include New Year's Day, Martin Luther King Day, Presidents' Day, Emancipation Day, Mother's Day, Memorial Day, Father's Day, Independence Day, Labor Day, Columbus Day, Veteran's Day, Thanksgiving, Halloween, Christmas, Easter, New Year's Eve, or other holidays. In some embodiments, the event may be man-made such as a holiday, Day Light Savings Time change, political elections, or other man-made events. In other embodiments, the event type may be a natural event such as a solar eclipse, lunar eclipse, aurora borealis, a visible comet passing by, a meteor shower, or other natural events. Event location may comprise the geographic location of an event. A geographic location can be specific GPS coordinates. A geographic location may comprise a city block, a neighborhood, a city, a county, a stretch of highway, a park, a recreation area, a sports stadium, a convention center, an area block, or other geographic location.

Event data may be sourced from one or more private or public calendars. For example, some states, municipalities, public organizations have publicly available calendars such as the California Data Portal. Many private organizations have a schedule of events on their website or in brochures and promotional materials such as the Chicago Cubs organization. When specific information about the event is not available, e.g., the time of the event, a forecast for the time may be set based on previous such events.

### Subject Data

Subject data refers to data from subjects through their communication devices (such as mobile phones, wearable devices, etc.). In some embodiments, subject data includes historical or current locational information (e.g., GPS information or location within a building, etc.). In some embodiments, subject data may include subject's travel information including speed and direction of travel. From such information, a subject's trajectory or future location may be estimated. Subject data can include future data. Future data may comprise a future location at a future time for one or more subjects. Future location at the future time can be calculated using subject location, direction of travel, speed of travel, path of travel, mode of transportation, or any combination thereof.

Subject data may comprise subject location. Subject data may comprise current location. Subject location may comprise historical location. Subject location may comprise GPS coordinates. Subject location may comprise altitude. Subject data may comprise direction of travel. Subject data may comprise speed of travel. Subject data may comprise path of travel. Subject data may comprise mode of transportation. Mode of transportation may comprise land transportation, water transportation, air transportation, or any combination thereof. Mode of transportation may comprise automobile transportation, train transportation, bicycle transportation, motorcycle transportation, airplane transportation, boat transportation, subway transportation, foot transportation, or any combination thereof.

In some situations, the current subject location may not be available because of various reasons such as loss of internet connectivity, weak GPS signal, etc. It is contemplated that the last known subject location may be used or an estimate of current subject location can be estimated.

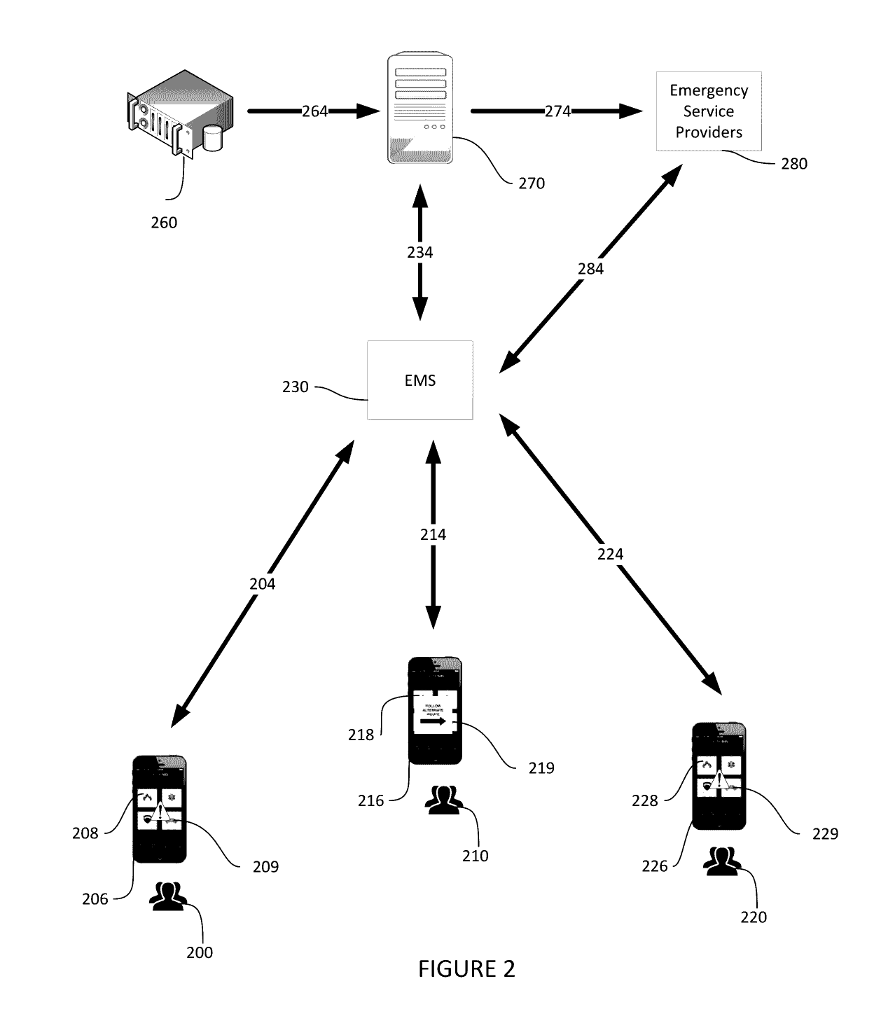

FIG. 2 is an illustration of one embodiment of the emergency prediction system for generating a risk prediction and communicating a warning and/or warning message to subjects on their mobile wireless devices. As shown, the system includes a prediction server 270, which communicates with an environmental information server (EIS) 260 and periodically receives from the EIS updated information about one or more man-made and natural environmental variables. The prediction server 270 also communicates with an Emergency Messaging System (EMS) 230 and periodically receives emergency data in the form of historical emergency call requests in a specific geographic location of interest. The EMS 230 communicates with the subjects 200, 210, 220 via data communication links 204, 214, 224 with the mobile wireless devices 206, 216 and 226.

Although not shown, the predictor server 270 may receive information from the mobile wireless devices, specifically subject data autonomously generated by the mobile wireless devices 206, 216 and 226. In some embodiments, the subjects 200, 210, 220 may enter into the mobile wireless devices 206, 216 and 226 information about environmental data at the geographic locations of the subjects 200, 210, 220 for the purpose of updating the prediction server 270.

The prediction server 270, after receiving information about the environmental data and the emergency data, and in some instances subject data to create a model for emergencies and a risk prediction. For subjects 200, 210, 220 in a given geographic location as determined by the location of the mobile wireless devices 206, 216 and 226, the prediction server 270, may send warnings 209, 229 and warning messages 219 to the devices. As shown, the devices 206, 216 and 226 include software application 208, 218, 228, which allows the subjects to communicate with the EMS. For example, warnings 209, 229 might indicate that there is a high risk of emergencies occurring because of freezing temperatures on Thanksgiving Day. In some embodiments, the warning message 219 may suggest alternate routes (such as a safer driving route) or preventative measures (such as taking public transportation options) that may reduce risk of emergencies.

In addition to warning subjects, the prediction server 270 may communicate with emergency service providers 280 for allocating resources such as staffing in emergency rooms, medical supplies for hospitals in the area or available in ambulances, police presence on certain roads and intersections, fire personnel who are on call, etc. The emergency service providers 280 such as hospitals, police and fire departments may communicate directly with the prediction server 270 in order to allocate resources and manpower to effectively and efficiently address emergency situations that are expected to occur based on the prediction algorithm.

The emergency prediction system may receive one or more instructions to provide one or more risk predictions from an emergency management system and sends the one or more risk predictions to the emergency management system. In other embodiments, the emergency prediction system may provide one or more risk predictions to one or more emergency management systems or emergency dispatch centers, wherein the risk predictions may enhance allocation of emergency response resources in preparation for future emergency requests.

### Prediction Algorithm

The prediction algorithm 194 (not shown) comprises a set of instructions that are carried out by a modeling module of a prediction server or emergency prediction system to generate a prediction model capable of making risk predictions. The algorithm 194 may contain instructions regarding the type and content of input data for the prediction and how to process the data, if needed. The algorithm 194 may contain instructions on how to build and apply a prediction model from the input data and apply to current or forecast data to make a risk prediction. The algorithm 194 may also contain instructions on how to use the risk prediction to decide whether to send warnings and/or messages to which subject devices.

The prediction model 190 (not shown) may be a mathematical expression that includes several independent variables to calculate an unknown or a dependent variable. A process of regression may be used to calculate the coefficients for the independent variables.

The model 190 may use several types of regression including linear regression, logistic regression, polynomial regression, stepwise regression, ridge regression, lasso regression and ElasticNet regression. In addition, model 190 may be a non-linear regression in which the data may be fitted by successive approximations.

In some embodiments, the model 190 may utilize linear regression, K-means clustering, non-linear least squares regression (NLLS), statistical testing (such as T-tests, chi-squared tests, Z-tests, etc.), logistical regression, and self-learning schemes, etc. In some embodiments, least squares may be used for fitting data into the model 190.

A prediction model may generate a risk prediction upon receiving input data corresponding to a defined emergency, defined geographic area, and a defined time period. The input data may be current or forecast data (e.g. future data) are the values for the independent variables that can be supplied to the prediction model to generate the risk prediction. Forecast data may be the same as future data. Data corresponding to current environmental conditions (environment type, environment location, environment time) may be used to generate a risk prediction. For example, the forecasted temperature on Thanksgiving morning may be used to generate a risk prediction for that day.

In other cases, the environmental conditions at a future time can be estimated or forecasted and applied to the model, e.g., the temperature forecast for Thanksgiving Day a few days before that day. For this purpose, weather forecast data may be publicly or privately available. In addition, standard techniques for estimating or forecasting the data may be used.

A risk prediction may be the risk of an emergency and it may be specific to a particular type of emergency within a defined geographic location within a defined time period. In some embodiments, the risk may be expressed in number of emergency calls expected from a geographical area within a certain timeframe. In other embodiments, the risk may be expressed as a percentage (e.g., a percentage increase or decrease from a baseline level of emergency calls). In some embodiments, the risk may be expressed as a probability distribution showing the number of emergency calls and its corresponding probability.

The risk prediction may be compared with a baseline level of risk, which may represent a general level of risk. If the risk is greater than the baseline, then the risk prediction shows an elevated level of risk. However, a threshold level of risk may be defined, which may be pre-defined value that is understood to be a significantly elevated risk (e.g. predefined risk threshold), wherein an emergency prediction system may send a warning to subjects within the defined geographic area and defined time period of a risk prediction that exceeds the predefined risk threshold. In some embodiments, the risk threshold may be defined as a certain fold or percentage increase from the baseline level of risk, e.g., risk elevation of 20%.

The warning may include a warning that there is an elevated risk for certain types of emergencies within a geographical location during a specific time period. Warning messages may recommend preventative measures that the subject may take to reduce risk for certain types of emergencies within a geographical location during a specific time period.

### Updating the Prediction Model

An emergency prediction system or prediction server may update a prediction model to capture new trends and phenomenon. In some embodiments, when actual emergency data is available for checking fit of the prediction model, the model fit may be evaluated.

Whenever emergency data becomes available to check fit (e.g., the future time corresponding to the risk prediction has passed and actual emergency data is available), the algorithm may check the fit (act 1124, 1126). In some embodiments, the fit error may be calculated by comparing error predicted and actual emergency data values (act 1128). If the fit error is within acceptable limits, the model fit is good and the calculated risk prediction can be used to send warning signals.

In some embodiments, the algorithm may attempt to improve the fit by performing significance analysis for the predictor variables in the existing prediction model and eliminating one or more insignificant variables. First, an administrator may be prompted to guide the model update (adjustment of coefficients, intercepts and/or regeneration of model with different set of predictor variables, change data cut) (act 1138). Any known method for variable selection or elimination may be utilized such as forward selection, backwards elimination and stepwise regression, etc. In some embodiments, when the prediction model is a regression equation, other methods may be employed including data splitting, bootstrap, etc. After making changes to the variables, the algorithm may run the prediction algorithm to create a new or updated model using one or more algorithms (e.g., linear regression, geospatial regression analysis, non-linear regression, or one or more other forms of prediction algorithms such as machine learning, etc.) (act 1138). The algorithm may then perform significance analysis or testing to eliminate one or more insignificant variables (act 1134). The updated model may be used to re-calculate risk prediction (act 1136) and re-check the fit error (act 1128). In some embodiments, if subsequent iterations do not bring the fit error within acceptable limits, the algorithm may prompt the Administrator to guide the model update (e.g., adjustment of coefficients, intercepts and/or regeneration of model with different set of predictor variables, change data cut, etc.) to improve fit.

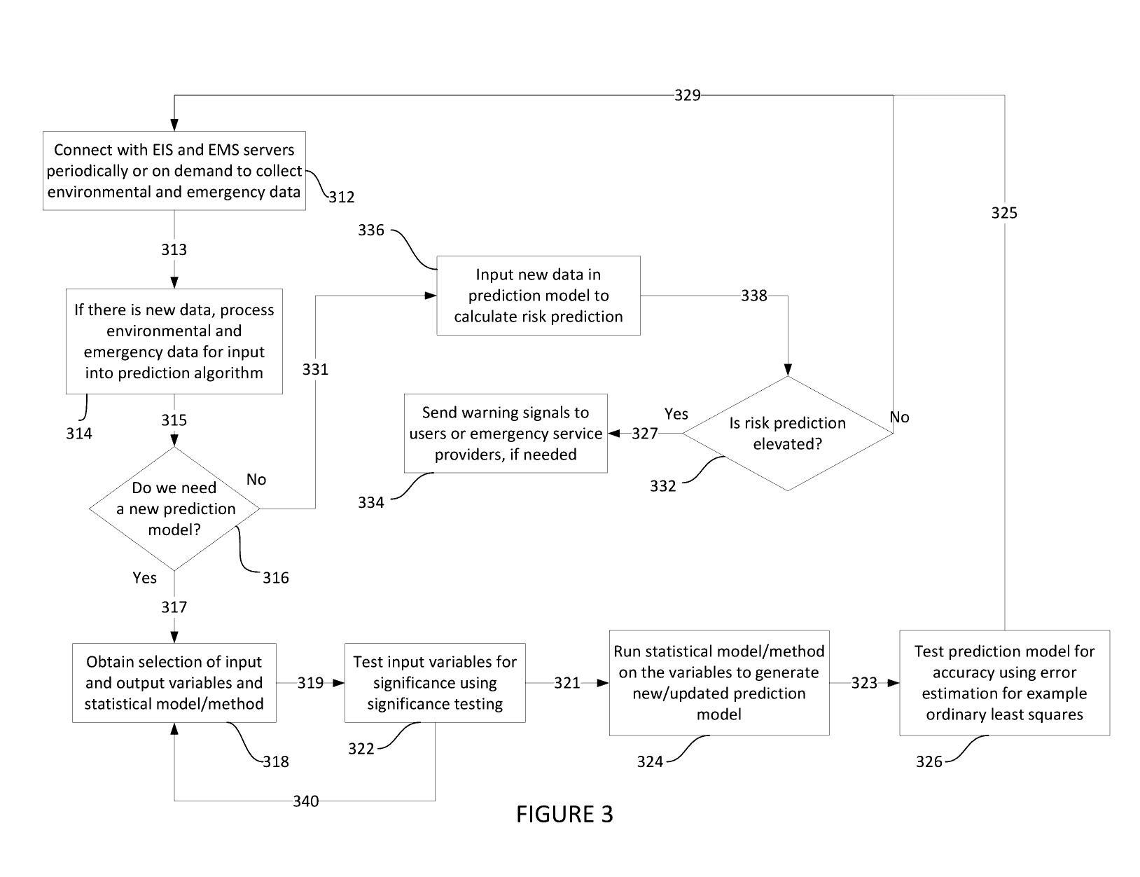

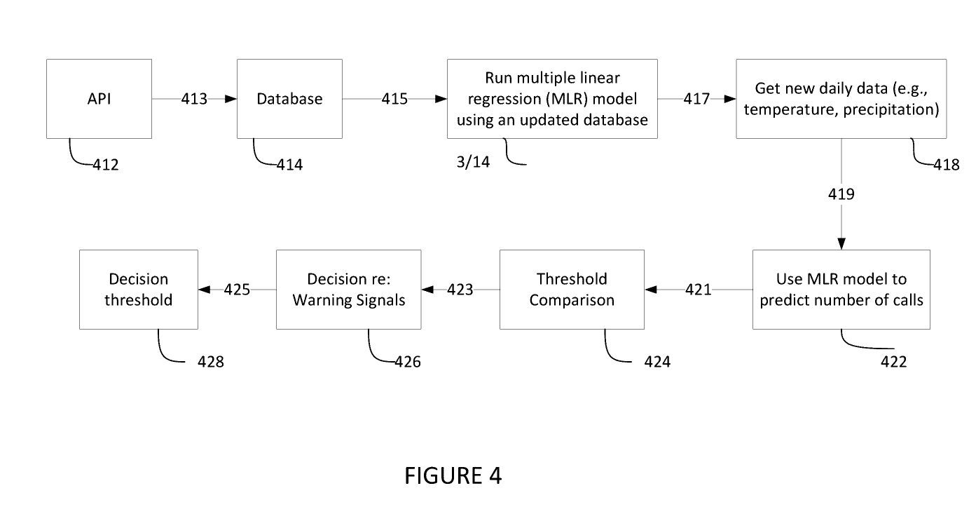

FIG. 3 is an illustration of how a prediction algorithm may calculate a risk prediction for emergencies using a prediction model. In some embodiments, the prediction server 270 (see FIG. 2) may poll and receive environmental data from the EIS 260 and emergency data (e.g., historical call data) from the EMS 230 (act 312), either on a periodic basis or as a response to a request sent by the prediction server 270 or the EMS 260. In some embodiments, the prediction model may be based on multiple linear regression (MLR) using ordinary least square (OLS). In some embodiments, the prediction model may be based on any other type of regression or machine learning, as described with respect to FIGS. 4 and 5.

As shown, if there is new environmental and/or emergency data, the data will be processed into a format that is suitable for inputting into the prediction algorithm for creating the prediction model (e.g., the least square calculation) (act 314). For this step, the algorithm will compare the existing data and compare to polled data to see if any data has been added or changed. The new data may be in the form of additional entries or data points for one or more environmental data, which have been already used as predictor variables in the prediction model. In other embodiments, the new data may be in the form of additional types of environmental data that have not been incorporated into the prediction model previously. The new data may also not be sufficient for using in the prediction model (e.g., environmental data for all the predictor variables in the prediction model may not be available). If there is no new data or if the data is not sufficient for using in the prediction model, then the algorithm will return data collection (act 312).

In some embodiments, the prediction algorithm may verify if there is a need to generate a prediction model (act 316) by checking if there is an existing model and using new data to check the fit of the model. If there is an existing prediction model that is saved in the system, there may be a need for a new model if the fit is not acceptable. If the same data has been used before in the prediction algorithm and an initial prediction model (e.g., MLR equation) has been formed for predicting the unknown or dependent variables, then the algorithm will input the new data into the prediction model to calculate the risk prediction (act 336).

In some embodiments, the algorithm will check the fit of the prediction model when actual emergency data is available. Thus, if some risk prediction at a future time was calculated and that time has passed, the actual emergency data may be used to calculate the fit error by comparing the actual emergency data with the risk prediction.

In some embodiments, the administrator(s) may review the model, the risk prediction and the fit error and make adjustments to the input data or the choice of variables to bring the fit error within acceptable limits (not shown). In this way, the prediction model can be updated with new data and new variables to capture and incorporate new trends and phenomenon.

If a new prediction model is needed (act 316), the algorithm may obtain a list of predictor (e.g. environmental condition, event, etc) and predicted variables (e.g. number of emergency calls) and a mathematical formulation to use to generate a relationship between these two types of variables (act 318). In some embodiments, an administrator(s) may be allowed to select the predictor variables and/or the statistical methods used to generate the prediction model. The algorithm may allow administrator(s) to select input in different ways to make the algorithm more accurate and efficient. Further, the prediction algorithm may test the significance of each of the predictor variables in order to be included in the prediction equation (act 322). The input variables may be subjected to significance testing (act 322) to determine the significance of the variable's relationship to the predicted risk.

Then, the prediction algorithm may be run on environmental and emergency data to create a prediction model (act 324). The prediction model may be a MLR prediction model that now has new coefficients for the variables. The prediction algorithm may use any known mathematical relationship or statistical methods/models to model the input data including regression, machine learning, etc. The prediction model may then be tested for accuracy (act 326). The prediction model then then repeat step 312 to query EIS and EMS servers for new data. If no new prediction model is needed (act 331), then the current model may then be used to generate a risk prediction (336).

The prediction model may be used to generate the risk prediction for a future time (act 324). In some embodiments, current or forecast environmental data may be applied to the prediction model to calculate the risk prediction. In some embodiments, the query for the future date may be entered by an administrator(s), the EMS, or an emergency service provider. In some embodiments, the current environmental data may be used to estimate the environmental data at a future time. In some cases, when the time interval is short, the current value for environmental data may be used to calculate the risk prediction. In other cases, public or private databases may be used to locate forecast data regarding environmental data.

In some embodiments, the algorithm may also determine if the risk prediction is elevated by comparing to pre-defined threshold. If needed, warning signals may be sent to subjects or emergency service providers. Detailed description regarding “elevated risk” and “warning signals” may be found elsewhere in this disclosure.

In some embodiments, the algorithm may compare the fit error is within acceptable limits (e.g., plus or minus 0.5%, 1%, 2%, 3%, 5%, 10%, etc.). In some embodiments, the fit error for different location or different times may vary. In those situations, the fit error may be aggregated or each fit error may be compared individually. If the fit error is within acceptable limits, the algorithm will return to polling for data periodically or on demand.

If the new data fits within the model with low error fit (or within acceptable limits), the prediction model is retained and there is no need to update the model. If the new data does not fit with low fit error (e.g., based on an error threshold), then the algorithm will add the new data and apply linear regression to generate a new model that captures the new data.

If the fit error is not within acceptable limits, the algorithm may alert the administrator(s) with a message such as the “the fit of the prediction model is not within acceptable limits and the prediction model may need to be updated”. The algorithm may then generate a new prediction model. In some embodiments, the algorithm may select predictor variables using packages for forward selection and backward elimination. In other embodiments, the algorithm may allow an administrator(s) select variables for the prediction model.

FIG. 4 is an illustration of an embodiment of a prediction server in which a prediction algorithm is based on regression. In the prediction server 270 (see FIG. 2), a prediction algorithm may create a prediction model based on least squared estimate calculations. The API 412 may receive historical environmental data, emergency call data regarding a geographical location, and subject data for a specific location. The application program interface (API) may be a set of routines, protocols, and tools for building software applications housed on the prediction server. The API 412 may send the environmental and emergency data to the database 414 housed within the prediction server. The data from the database 414 may be input into the regression module 416 (e.g., multiple linear regression (MLR)) to generate a prediction model. In some embodiments, the values of the various variables may be squared and then fed into a regression equation by weighing each value with appropriate weights, as specified by the ordinary least square regression equation, or by another regression equation as specified by the logical regression algorithm. The regression equation may be used to generate risk predictions of the occurrence of one or more emergencies, which may be in the form of probabilities. In addition to linear regression, other types of regression include logistic regression, polynomial regression, stepwise regression, ridge regression, lasso regression and ElasticNet regression may be used. In other embodiments, gradient descent may be used instead of regression.

The algorithm may utilize new data for environmental variables as they become available (e.g., temperature, precipitation) in the current data module 418. In other embodiments, the algorithm may apply forecast data to the prediction model. In some embodiments, a MLR model may be used to predict number of emergency calls in the risk module 422.

In some embodiments, the predicted values may be compared to the actual occurrence or non-occurrence of the predicted emergencies and this coupled with the updated information from communication device and the weather database servers and other sources of information, which may be used to update the weights of the variables in the OLS equation in the regression module (not shown). If differences between the predicted occurrences or non-occurrences and actual occurrences or non-occurrences of the predicted emergencies are more than acceptable as determined in an error estimate and the weight adjustment, the weights of the variables in the OLS equation may be adjusted to bring the error value below the acceptable error levels and the intercepts may be adjusted, as needed (not shown).

The risk predictions (number of calls) obtained in 422 may be compared to one or more pre-defined thresholds for each of the emergency types in a threshold comparison module 424. Based on this comparison, a decision may be rendered whether or not a certain type of emergency event has a higher than normal probability of occurrence, within a specific time-frame, in a specific geographic location by decision module 426. In some embodiments, the decision may be fed to a decision threshold counter module 428. If a counter in the decision threshold counter module 428 exceeds a predefined threshold value a warning signal may be issued by the API 180 based on pre-defined criterion (e.g., the magnitude of the margin by which the predefined threshold value is exceeded). By using decision threshold 428, a warning will not issue every time there is an elevated risk prediction. The warning signal will issue when the risk prediction has been elevated for several counts.

The warning signal may be conveyed by the API, via digital signals, and over data communication links, to an EMS. The EMS may convey the warning signal to the subjects via their communication devices. In some embodiments, the prediction server or the EMS may send warning signals or messages to emergency service providers.

FIG. 5 is an illustration of an embodiment of a prediction server in which a prediction algorithm is based on a self-learning scheme. In a prediction server 270 (see FIG. 2), the prediction algorithm creates a prediction model based on self-learning schemes. The API 512 may receive historical environmental data, emergency call data regarding a geographical location, and subject data for a specific location. In some embodiments, the API 512 may send the environmental and emergency data to the database 514 housed within the prediction server. The data from the database 514 may be input into the prediction algorithm and machine learning may be used.

In some embodiments, environmental and emergency data (“the input data”) may be queued for being inputted to the self-learning scheme in the queuing module 516 for online testing. In some embodiments, the input data may be separated into training, validation and/or testing data for the self-learning scheme. In some embodiments, the input data may be filtered or processed to be in suitable format for input into the self-learning scheme. In some embodiments, the input data may be normalized and an appropriate data cut may be chosen by the algorithm or an administrative subject.

In some embodiments, the training and validation of the self-learning scheme for estimating the prediction model may be done in the modeling module 518. The segregated training data may be used to estimate the prediction model, while the validation data may be used to validate that the prediction model is accurate. In some embodiments, prediction accuracy for emergency calls or call volume may be mean square error. In some embodiments, prediction accuracy for probability of risk prediction may be percent of correct classifications, KL divergence, etc. A prediction accuracy may be an accuracy score. In some embodiments, a prediction accuracy may be used to calculate an accuracy score. For example, a prediction accuracy may be a ratio or percentage of the risk prediction and the actual risk. If a risk prediction comprises a prediction of 40 emergency calls, while the actual risk turns out to be 50 emergency calls, then the prediction accuracy may be 4:5 or 80%, indicating the risk prediction predicted 80% of the actual risk. An accuracy score for the risk prediction may be the prediction accuracy itself, e.g., 80% or 0.8. An accuracy score may be a rule-based calculation generated from the prediction accuracy. For example, a set of rules relating to the accuracy score may require that a prediction accuracy for a risk prediction fall within a deviation threshold of the actual risk. For example, a deviation threshold may be 20%, wherein the threshold comprises the range between a 20% underestimation and a 20% overestimation of the actual risk (e.g. between 80% and 120%). In this example, any risk prediction value that falls within the deviation threshold may be labeled as being “accurate” and assigned an arbitrary value of “1.” In addition, the set of rules may state that any risk prediction outside the “accurate” prediction accuracy is deemed “inaccurate” and assigned an arbitrary value of “0.” Prediction accuracy and/or accuracy score may be calculated for each risk prediction. A deviation threshold may be 0%, 5%, 10%, 15%, 20%, 25%, 30%, 35%, 40%, 45%, 50%, 55%, 60%, 65%, 70%, 75%, 80%, 85%, 90%, 95%, or 100% or more.

The prediction accuracy and/or accuracy score for each risk prediction may be stored by the data module for purposes of assessing the overall accuracy of the prediction model. A modeling module may assess a prediction model for accuracy using the prediction accuracy and/or accuracy score for each risk prediction generated by the prediction model. A modeling module may assess a prediction model for accuracy by obtaining the average of a plurality of accuracy scores for a plurality of risk predictions and comparing the average to an accuracy threshold. An accuracy threshold can be an arbitrary value pre-defined by the modeling module or by a subject or user. A modeling module may follow a rule to create a new prediction model when the original prediction model falls below an accuracy threshold. For example, when accurate predictions are assigned an accuracy score of 1 while inaccurate predictions are assigned an accuracy score of 0, the modeling module may set an accuracy threshold of 0.9 or 90% so that at least 90% of the plurality of risk predictions generated by the prediction model must be accurate for the model to continue to be used. Otherwise, if the average of the accuracy scores fall below 0.9, the modeling module may generate a new prediction model incorporating new or additional data and/or removing old or obsolete data to improve prediction accuracy. An accuracy threshold may be selected from the group consisting of: 0.99, 0.95, 0.9, 0.8, 0.7, 0.6, 0.5, 0.4, 0.3, 0.2, and 0.1.

In some embodiments, a modeling module may test a prediction model by generating the model with data not including a subset of the data comprising actual risk information, and then interrogating the model with the subset of data to determine prediction accuracy and/or accuracy score for each risk prediction.

The algorithm may comprise a self-learning scheme or algorithm. The self-learning scheme/algorithm may generate one or more risk predictions by entering test data (e.g. subset of data comprising actual risk information that is not used to generate the prediction model) into the prediction model and compare the risk predictions to the actual risk. For example, the self-learning algorithm may use the risk module 522 to input test data into a prediction model to calculate risk predictions. In some embodiments, a feedback loop may be used to constantly or repeatedly improve the self-learning scheme. In some embodiments, when the actual event has passed and the actual emergency data is available (e.g. actual risk information), errors in classification or risk prediction may be calculated, by comparing the predicted probabilities (risk prediction) to actual occurrences of the emergency situations (actual risk), and data regarding the errors may be input back into the risk module 522 after the feedback loop to update the prediction model and improve the prediction accuracy.

The prediction algorithm may use any type of machine-learning scheme. For example, a classification method may be used for classifying the risk prediction into risk categories or probability of risk categories using any known method including Support Vector Machine (SVM), Random Forest (RF), Naïve Bayes Classifier, neural networks, deep neural networks, logistic regression, etc. Classification classes may include “Elevated risk”, “High risk”, “Excessive risk”, “Moderate risk”, “Low risk”, etc. In other embodiments, regression may be used to calculate emergency data or number of emergency calls using known methods such as support vector regression, Gaussian process regression, neural networks for regression, etc.

If an increased probability of emergency calls or types of emergencies is determined in a threshold comparison module 524, by comparing the calculated probability to the probability of the same event with a baseline or threshold. Based on the, a decision may be rendered in the decision module 526 as to whether the risk level warrants sending warning signals to recipients including subjects or emergency service providers. If a decision is made to send the warning, the decision may be fed into a decision threshold module 528. If the decision to send a warning signal to the same recipients is repeated for a pre-defined count (e.g., 1, 2, 5, 10, etc.), a warning signal may be sent by the API 512 via digital signals over data communication links directly to the recipients. In other embodiments, the warning messages are sent to the EMS, which will forward them to the subjects via their communication devices.

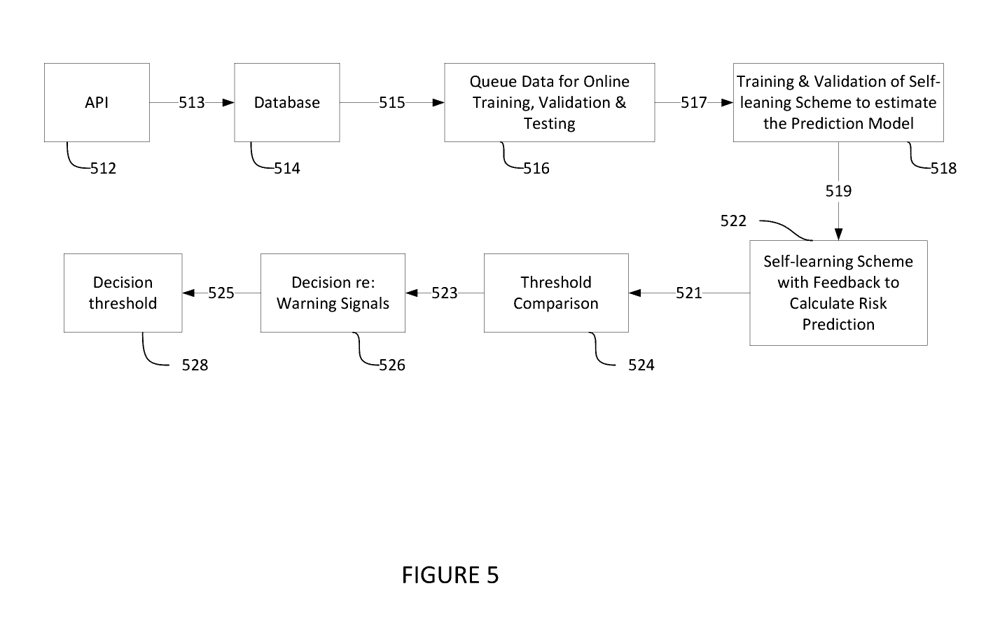

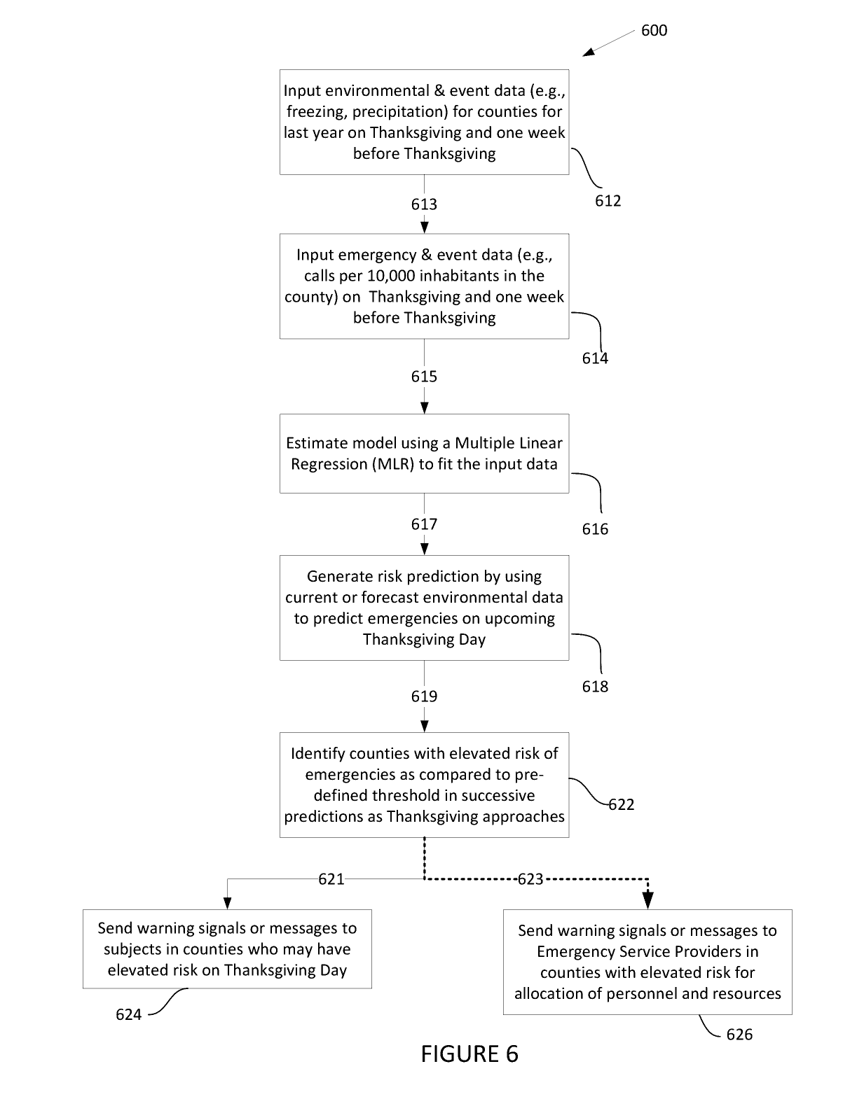

FIG. 6 is a flow chart illustrating one embodiment of a prediction algorithm 600 for calculating risk prediction for emergencies and sending warning signals to communication devices for Thanksgiving Day. In this example (Example 1), the number of emergency calls in a given geographical region (here, a group of counties were considered to increase the sample size) for the event of interest, Thanksgiving Day. As shown in FIG. 6, the prediction algorithm 600 includes several steps. The input data including environmental, event and emergency data is fed into the prediction algorithm 600 (act 612, 614). The environmental data includes “freezing” and “precipitation” data for each county for Thanksgiving and one week before while the emergency data includes emergency calls for the same (act 612, 614). Here, the event data includes the event of interest (i.e., Thanksgiving) and one week before Thanksgiving is being used as a baseline. As shown, the call data may be normalized to take into account population density (act 614). Next, multiple linear regression (MLR) is used to estimate a prediction model that fits the input data (i.e., the environmental, event and emergency data) (act 616). Then, the risk prediction is generated using current or forecast environmental data for the event of interest (i.e., Thanksgiving) and applying the prediction model (act 618). In some embodiments, the current temperature and precipitation the day before Thanksgiving are entered into the MLR equation (see Table 2) to obtain a predicted number of emergency calls on Thanksgiving. In other embodiments, the forecast data for Thanksgiving day may be used to predict the number of emergency calls on Thanksgiving.

In some embodiments, counties with elevated risk of emergencies may be identified by comparing the calculated risk prediction with a baseline or pre-defined threshold (act 622). In other embodiments, there may be a continuum of risk to capture the amount of risk including “elevated,” “excessive,” “high,” “moderate,” “low”, etc. For example, the elevated risk may be found in successive iterations before the algorithm will decide to send warning signals or messages (act 624, 626). In other cases, the magnitude of the elevated risk may be used to determine whether the risk is elevated. In addition, the risk prediction may be updated as Thanksgiving approaches to take into account an updated forecast for environmental data.

In some cases, warnings or messages may be sent to subjects in the counties with elevated risk (act 624). In some embodiments, warning signals or messages may also be sent to emergency service providers (ESPs) in counties with elevated risk for allocation of personnel and resources (act 626). In some embodiments, warning signals or messages may be sent only to ESPs.

Environmental variables that were used as inputs in the prediction algorithm 600 include historical daily environmental data for freezing and precipitation for one week before Thanksgiving and Thanksgiving Day in 2015. The “freezing” variable combines the temperatures for the day and categorical classification of 1 or 0 indicates if the freezing temperatures existed on that day or not respectively (specifically, whether the temperature reached below freezing—lesser or equal to 32° C.—or not). The “precipitation” variable is a continuous variable representing the amount of precipitation (in inches) for that day. It is supposed that the combination of the freezing and precipitation variables might capture if “black ice” conditions existed or not, which is known to contribute to traffic accidents.

The emergency data includes emergency calls from each geographical region for one week before Thanksgiving and Thanksgiving Day for 2015. The event data was captured as an “event” variable, which was 0 for a week before Thanksgiving or 1 for Thanksgiving Day. In this way, the day one week before Thanksgiving may be treated as a “regular” baseline day that can be used to understand the effect of Thanksgiving Day.

Exemplary emergency and environmental call data that were used to create prediction model for Example 1 is depicted in Table 1. In Table 2 depicts each data point and includes information regarding temperature, precipitation and number of calls. For each data point, the name of the county and a short-hand name are listed in column 1, the date for the data point (Thanksgiving or week before Thanksgiving) and the year are listed in column 2 and 3. Freezing values (listed in column 4) given a value of 1 if the temperature was lesser or equal to 32° C., or a 0 if it did not. In columns 5 and 6, the precipitation (in inches), e.g., snow, rain, sleet, and number of emergency calls are also listed.

TABLE 1

| | | | | | Precip- | Emer- |
|---|---|---|---|---|---|---|
| | | | | | itation | gency |
| County | Day | Year | Freezing | Event | (inches) | Calls |
| Fulton (C1) | Thanksgiving | 2015 | 0 | 1 | 0 | 3 |
| Saratoga (C2) | Week before | 2015 | 0 | 0 | 0.65 | 5 |
| | Thanksgiving | | | | | |
| Saratoga (C2) | Thanksgiving | 2015 | 1 | 1 | 0 | 10 |
| Washington (C3) | Thanksgiving | 2015 | 1 | 1 | 0 | 13 |

In the call data, there may be several categories of information that may be saved with each emergency call. In some embodiments, there may be a “timestamp” with the date and time of the emergency call and “locational information”, which is the GPS coordinates from which the call was made. If the subject's communication device includes a location determination module such as GPS, the GPS information may be saved in the call data. If the subject is calling from a landline, the address associated with the landlines may also be saved in the call data. In some embodiments, the type of emergency, the duration of the emergency call, fatalities or injuries reported in the emergency call, other locational information (e.g., whether the subject is at home or in a car, which highway they are driving on, etc.).

Emergency data is a critical component of this predictive algorithm. The emergency data may be in form of a call log with time stamp with GPS coordinates may be available from one or more EMS. In addition, raw call data may be filtered to remove inadvertent calls, prank calls, dropped calls, etc. For calls where the locational information was not available, the current or previous locational information (e.g., the county where a subject lives or works) may be inserted so that the emergency call can be taken into account.

A prediction model was generated fitting the input data using multiple linear regression. The model and the associated error values are exhibited in Table 2. The analysis of the residuals showed that the mean square error is not increasing with additional variables and that the model was a reasonable fit model. The adjusted R² value was 0.1481 indicating a tighter fit than the R² value. Further, a p-value of 0.011 implied that the model is significant at 90% confidence whereas the variable ‘event’ was significant at 99% confidence and freezing was significant at 95% confidence. The interaction between freezing and event was marginally significant and variable ‘precipitation’ was not significant.

TABLE 2

| | Calls = 5.29 − 2.58 * freezing − 0.013 * | | | |
|---|---|---|---|---|
| | precipitation + 2.39 * event | | | |
| Prediction Model for | Estimated Std. | | | |
| Emergency Calls | Error | t-value | Pr (>\|t\|) | |
| (Intercept) | 5.291 | 1.195 | 4.428 | 4.56e−5 |
| Freezing | −2.580 | 1.425 | −1.811 | 0.076 |
| Precipitation | −0.013 | 0.022 | −0.590 | 0.558 |
| Event | 2.397 | 0.825 | 2.905 | 0.00529 |
| Freezing:Precipitation | 0.0245 | 0.0321 | 0.763 | 0.449 |

The implications of the model may be: a) based on the large coefficient, event (i.e., whether it is Thanksgiving day or not) is associated with a large number of calls; b) the intercept (here, 5.29) corresponds with the baseline level of emergency calls for all the counties on a “regular” day (i.e., a day when it is not Thanksgiving, the temperature is above 32° C. and there is no precipitation); c) on freezing days, there are −2.58 calls for 100,000 inhabitants; d) precipitation is marginally significant; and e) on freezing days, an increase in 1% precipitation corresponds to an increase of 0.02 calls per 100,000 inhabitants.

To improve the model, other variables may be added to this prediction model. For example, traffic density may play a role in addition to the freezing precipitation and event variables in Example 1. It is understood that additional data (such as traffic density) may be collected from available sources and used to update the prediction model.

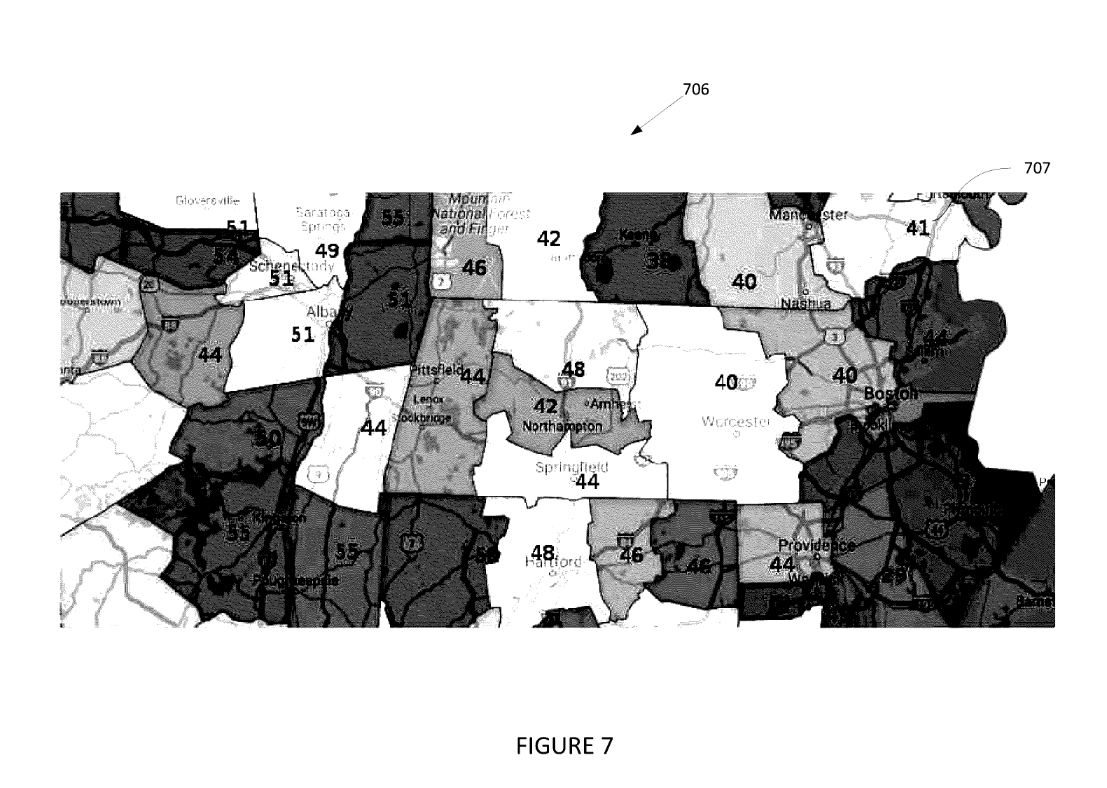

FIG. 7 depicts exemplary environmental data that may be inputted into the prediction algorithm to create the prediction model. Specifically, FIG. 7 is a visualization of the temperature on the day one week before Thanksgiving for thirty counties in Massachusetts in 2015. The environmental data (i.e., the temperature) for each county is aggregated and displayed on a locational map (e.g., 707). In some embodiments, atmospheric temperature may be taken on the same date at approximately the same time in different places in the county. In other embodiments, environmental data from different years on the same date may be aggregated. In some embodiments, environmental data for one or more days, one or more weeks, one or more months, one or more years may be aggregated for input into the prediction algorithm.

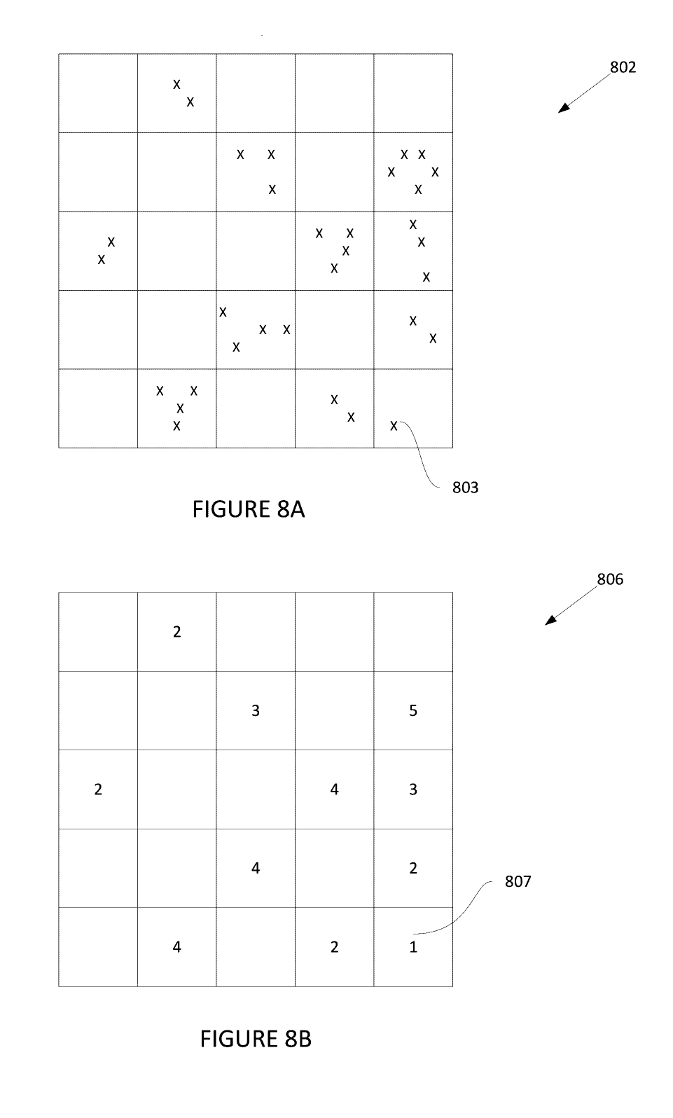

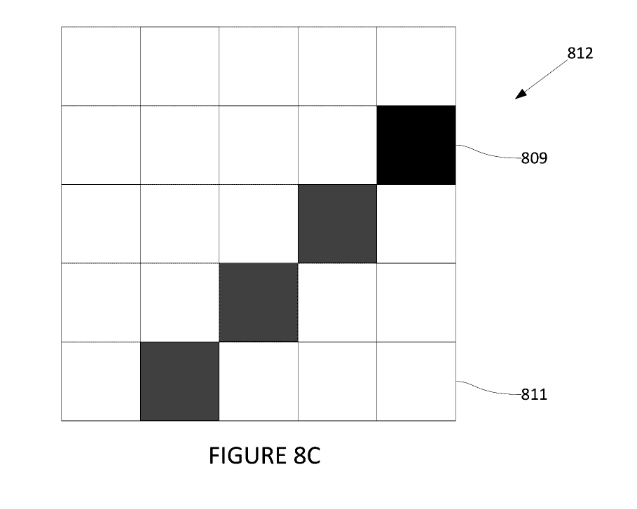

For Example 2, FIGS. 8A, 8B and 8C show emergency data, specifically the call data, on a locational map and also depict processing of the emergency data before generating the risk prediction. FIG. 8A shows exemplary call data, referred to as “the individual call data 802” that have been made within a definite time period (e.g., a 24 hours, 1-hour, 30 minutes, 2 days, 1 week, etc.). The individual call data 802 may be obtained from the raw data received by the EMS or other sources. In some embodiments, the raw data may be filtered remove dropped, duplicate or inadvertent calls, etc. In some embodiments, the raw data may be processed to supply missing information, wherever needed. For example, if the GPS coordinates from the subject's communication device is not available, then the last recorded location may be saved in the individual call data 802.

In FIG. 8A, the discrete call data 802 is exhibited on a locational grid (“grid”) with an individual emergency call 803 represented by an “X.” As shown, the grid is divided into a plurality of area blocks, each comprising, in this illustrative example, an area of 1 mile×1 mile square. A defined geographic area may comprise one or more area blocks. In other embodiments, the grids may be larger such as 1.5 mile×1.5 mile square, 2 mile×2 mile square, 10 mile×10 mile square, or 100 mile×100 mile square, etc. In some embodiments, the area blocks may be selected from various shapes such as a square, rectangle, circle, oval, triangle, hexagon, or other shape. Area blocks may comprise irregular shapes not defined by a simple geometric shape. Furthermore, the irregular-shaped counties in FIG. 7 may also be used for exhibiting and processing the call data in a similar fashion. In some embodiments, the grid may comprise a stretch of road, and emergency calls from that stretch may be represented and processed in a similar fashion. In some embodiments, the grid may be defined to be a neighborhood, township, sub-division, college campus, municipality, town, village or other locations.

In FIG. 8B, “aggregate call data 806” for each area block is calculated and exhibited. Here, the emergency calls within an area block (e.g., a specific 1 mile×1 mile square) is aggregated together to produce one aggregate call data for that area block 807. The aggregate call data 806 may quantify the aggregate call data in many different ways including use of decimal numbers or fractions, etc.

The systems, methods, and media described herein may apply specific rules to ensure that each emergency call is counted in the appropriate area block even in ambiguous circumstances. For example, if an emergency call is made while the subject was traveling from one area block to another, a rule may specify that the call is assigned or associated with the area block the subject was located in when the call was initiated. As another example, a rule may specify that the call is assigned or associated with the area block the subject was located upon the termination of the call. As yet another example, a rule may specify that the call is assigned or associated with the area block the subject received aid from emergency response personnel.

FIG. 8C shows an exemplary “call density map 812” generated from FIG. 8B. As shown, the shading for each grid indicates the density of calls in a continuum, wherein a darker shade represents more calls. For example, a darker area block 809 will have emergency calls than a lighter area block 811. In some embodiments, the degree of shading may be proportional to the call density. In other embodiments, various patterns and colors of shading may be used to represent the density of calls.

In some cases, normalization may be used to calculate per capita call density to take out effect of variations in call data from the prediction model due to other factors. In some embodiments, the call density may be normalized by the population in each locational grid to take into account variations in population density before generating the call density map 812. In some embodiments, the call density may be normalized by the number of motorists within each grid. Such traffic information may be obtained from or estimated using information from, for example, Google maps servers, traffic cameras, location information from user communication devices, public or private traffic databases, and/or other sources. In some embodiments, the call density may be normalized by proportion of population in demographic groups (e.g., proportion of population who are above 65 years of age). While risk predictions comprising aggregate emergencies for a defined emergency in a defined geographic location during a defined time period may be useful to a county for resource allocation purposes without requiring normalization, normalization may be useful for sending warnings to individuals or subjects who may be interested in their personal exposure to elevated risk rather than an overall number of predicted emergencies in their geographic area. For example, a major metropolitan area may have much larger aggregate number of kidnapping-related emergencies (predicted or actual risk) than a suburban or rural area, but may have a lower per capita risk due to the population differences. By normalizing the kidnapping-related emergency to a per capita risk basis using, for example, population census data in the defined geographic area, the systems, methods, and media described herein may provide warnings relevant to individuals.

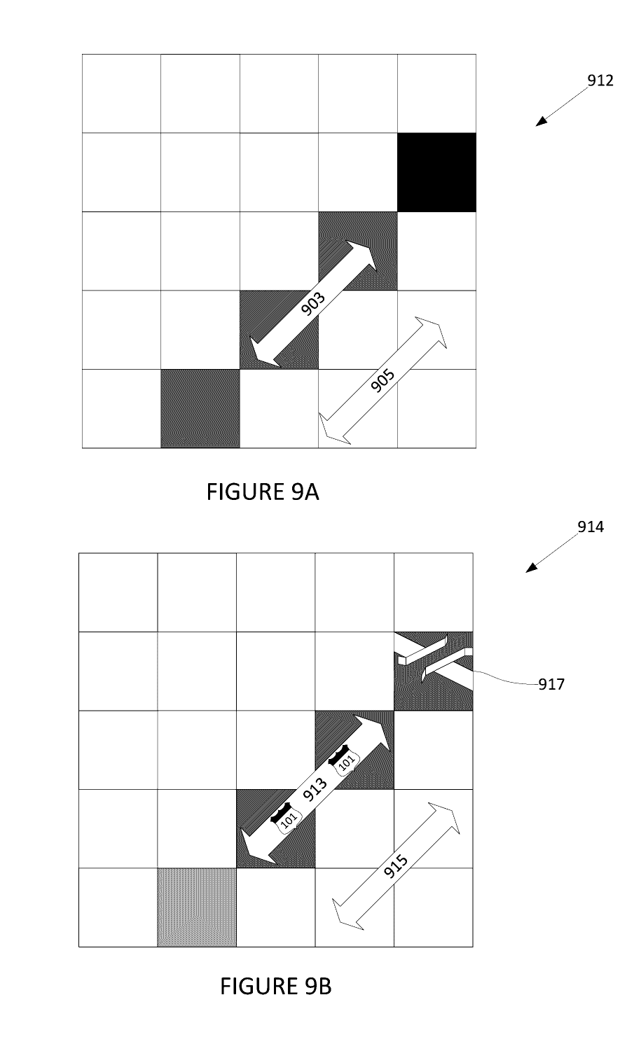

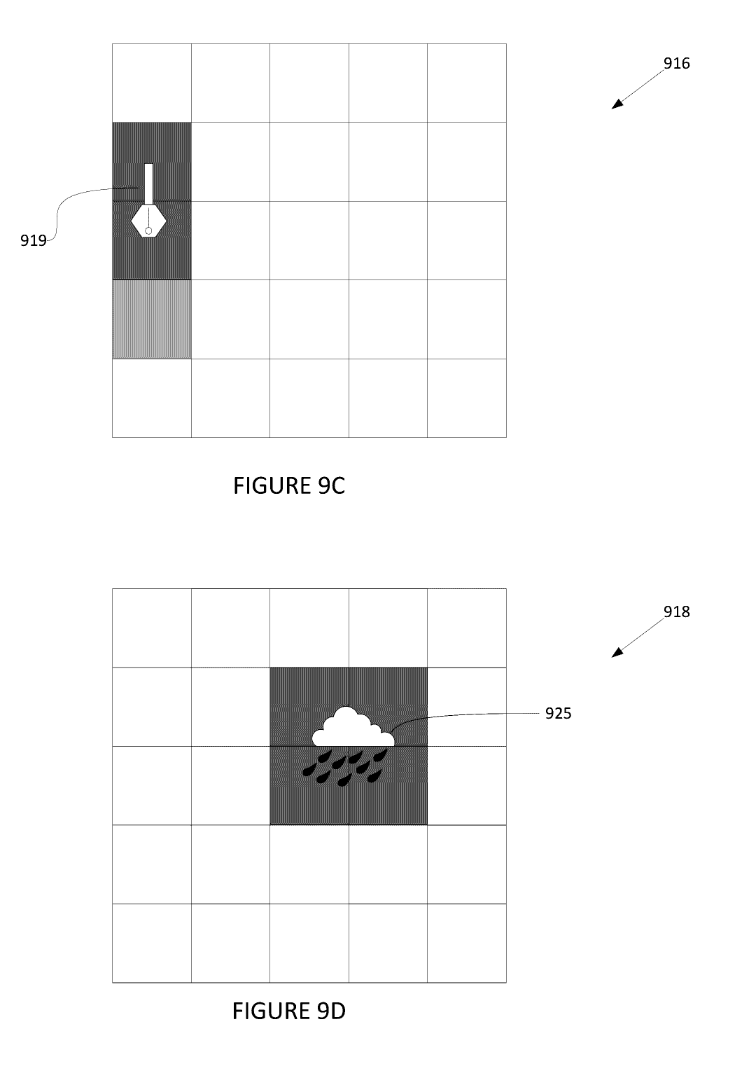

FIGS. 9A, 9B, 9C and 9D display input data including environmental and emergency data that may be used to create the prediction model. In contrast to Example 1, which assesses risk for an entire county, Example 2 visualizes the emergency data (i.e., call data) and environmental data (i.e., traffic density, temperature and precipitation) within a grid comprising area blocks that are, in this illustrative example, approximately 1×1 square mile area blocks. FIG. 9A shows an exemplary emergency call density map 912 as shown as call density map 812 in FIG. 8C. In some embodiments, the call density map 912 may be correlated with physical locations including highways, roads, neighborhoods, shopping complexes, sports or entertainment venues, etc. As shown, call density map may exhibit a pattern of calls on different highways such as call patterns 903 and 904.

FIG. 9B corresponds to an exemplary traffic density on the same locational grid on which the call density map 912 is shown. In some cases, traffic patterns 913, 915 may emerge showing that emergency calls are concentrated in consecutive area blocks or along specific paths. The traffic pattern 913 may be correlated to traffic on a specific highway (e.g., a main highway) and another traffic pattern 915 might correspond with traffic on another highway (e.g., an alternate route). In some embodiments, the location of potential safety hazards, such as bridge 917 may be identified based on location in specific area blocks to evaluate risk of emergencies in that area.

FIG. 9C is an exemplary temperature map with lower temperatures shown in darker shade associated with adverse road conditions. As illustrated, the lower temperatures are located towards the north-west section of the locational map. In this way, this map can capture a cold front 919. FIG. 9D is an exemplary precipitation map showing higher precipitation with darker shade corresponding with adverse driving conditions. As illustrated, the higher precipitation is concentrated in the middle-north section of the locational map. In this way, a storm 925 can be captured in the locational grid and its impact on emergencies can be evaluated.

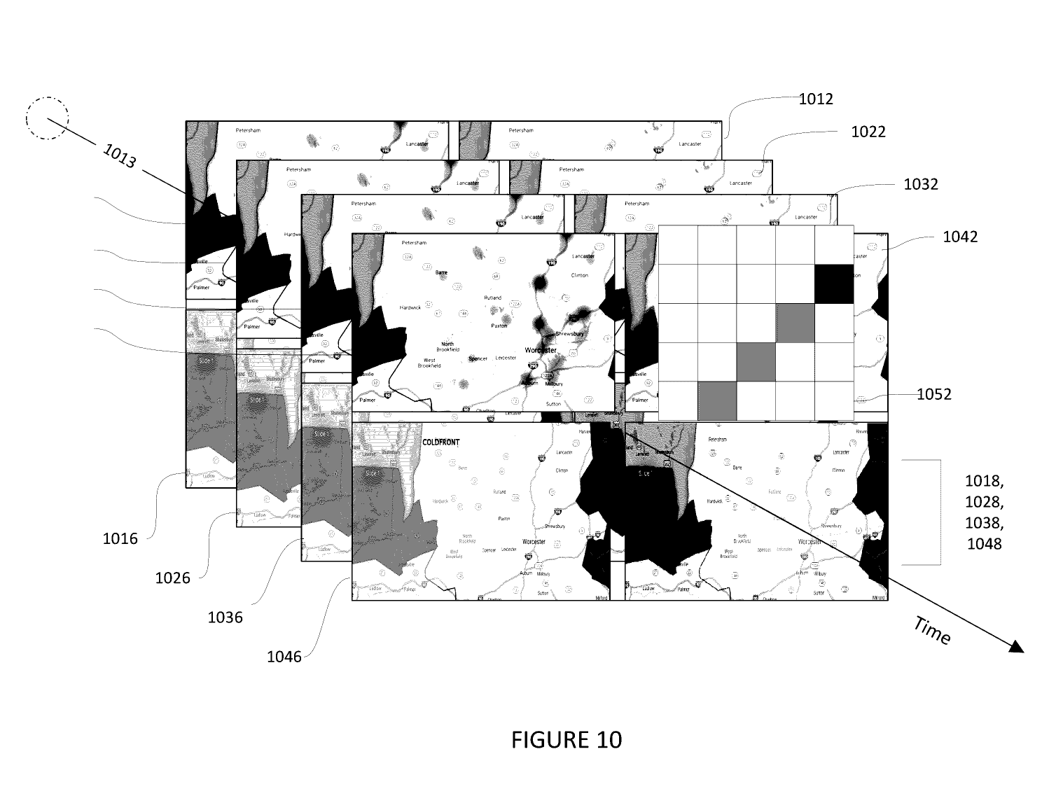

FIG. 10 illustrates one example of how various environmental and emergency data from time instances may be used to generate a risk probability map 1052. In Example 2, the event data may be any chosen event of interest and the time instances may be prior to that event of interest. The environmental data may consist of traffic density, temperature map, precipitation, and call density for different time instances on the same locational map. As shown, the environmental and emergency data depict the data at t=1, t=2, t=3, t=4 along a time axis 1013.

As shown, the traffic density maps 1014, 1024, 1034, 1044 show the traffic density in the four time instances. The time interval between these time instances may vary from 1 second to 1 week including hourly. For example, the time interval may be 10 minutes and changes in traffic density may be captured in real time. The temperature maps 1016, 1026, 1036, 1046 at different time instances may be able to exhibit a cold front in motion. The precipitation maps 1018, 1028, 1038, 1048 at different time instances may be used to monitor how a storm may be developing.

The emergency data, specifically, the call data at different time instances is represented by call density maps 1012, 1022, 1032, 1042. Using the prediction algorithm, the emergency and environmental data may be used to generate a prediction model for emergencies. Using the model, the risk probability of emergency calls (risk predictions) can be generated and used to create a risk probability map 1052 for a future time instance (t=5). The risk probability map may be shown on a display or user interface. The risk probability map may be displayed as a geographic map.

For example, the risk probability map 1052 may be obtained by inputting exemplary data from FIGS. 9A, 9B, 9C and 9D to generate a prediction model using current or forecast data (e.g., forecast for traffic density, temperature, precipitation) to calculate the risk prediction for each area block. Using the risk prediction for each area block, a risk probability map 1052 may be generated.

In some embodiments, the risk probability map 1052 may show areas of higher risk by use of a darker shade, as shown. The higher risk of emergency may be normalized for population, number of vehicles or motorists, demographics, etc. to remove effect of other factors on number of calls.

In some embodiments, the risk probability may be compared to thresholds and determined that the risk is elevated. If the risk is elevated for one or more counts or for a specific amount of time, warning signals may be sent to subjects in the specific locational grid, in adjacent grids or to the entire geographical area.

Based on these illustrated risk predictions, the prediction algorithm may send warning signals to subjects via their communication devices. Warning messages may also be sent recommending driving on alternate route as an alternative to the main highway. In some embodiments, the warning signals or messages may be sent to all subjects who are located within the geographical location based on current subject location. In other embodiments, the messages may be targeted to subjects who are driving or in vehicles based on whether they are in driving mode or based on their current speed and direction of travel. In some embodiments, the warning signals or messages could be sent to certain demographics based on subjects who are likely to encounter emergency situations.

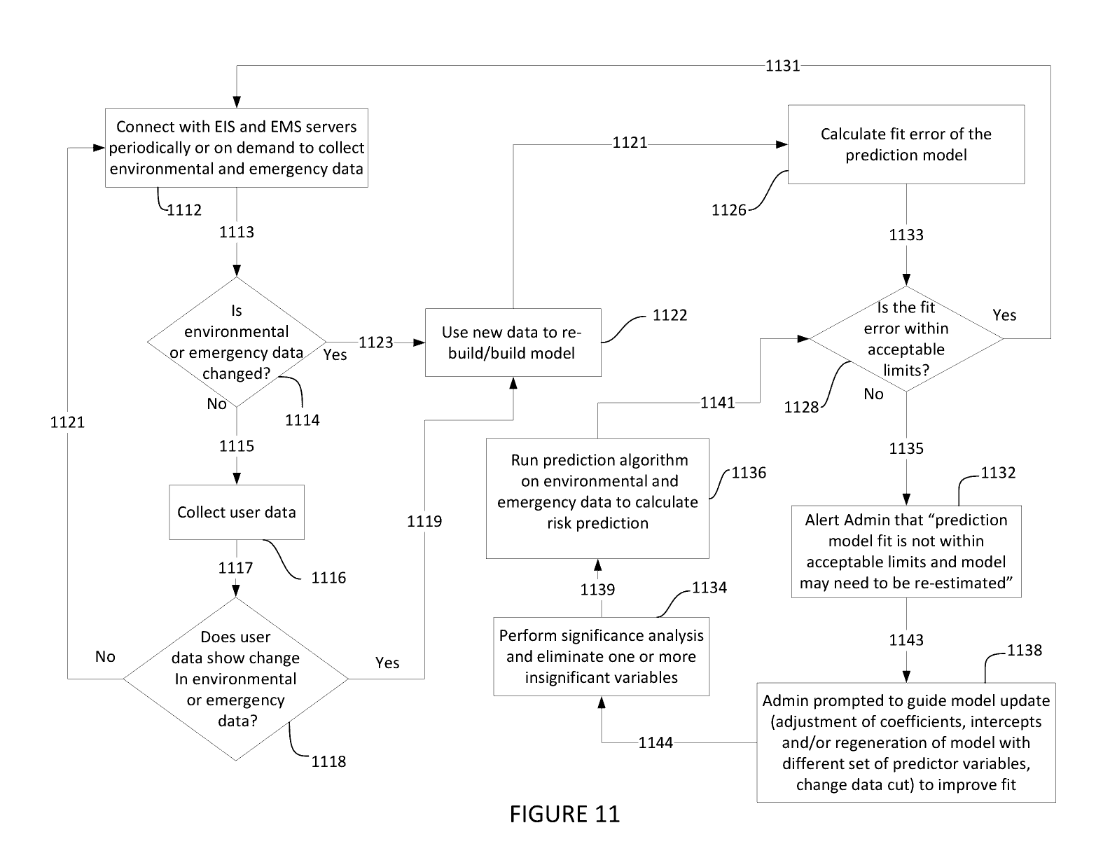

FIG. 11 shows a flow chart illustrating one embodiment of a process to build a model for prediction of emergencies at an emergency prediction system. In some embodiments, the environmental and emergency data may have been used to create a prediction model and the prediction algorithm may apply that model to new data or update the model, if needed. In some embodiments, the prediction algorithm may allow for an Admin, or anyone with administrative access to the prediction server, to guide updating of the prediction model at various points.

The prediction server data module may connect to one or more environmental information server (EIS) to collect historical environmental data and also connecting with one or more EMS for collecting emergency data (act 1112) periodically or on demand. The prediction algorithm may compare the historical information provided by the EIS and the EMS with the last saved environmental and emergency data at the prediction server to evaluate if the data has been changed (act 1114). In some embodiments, the data module may collect historical and/or current environmental data for purposes of forecasting future environmental data. A data module may collect future environmental data instead of forecasting future environmental data.

In some cases, there may be new entries in already used categories of data (e.g., temperature, precipitation values), i.e., which may have become variable predictors in the prediction model. If there are new categories of data (e.g., wind speed), which have been used in the prediction model, the Admin may incorporate in the prediction model to improve fit (act 1138). In some embodiments, Admin input may be taken initially when new categories of data are identified for input about whether those should be incorporated to update the prediction model (not shown).

Although not shown, if there is a change in either of the environmental data or the emergency data, the prediction server may check to see if there is sufficient data to calculate risk prediction by applying in the existing prediction model (e.g., values of several independent variables are known within a specific timeframe). For example, new or updated forecast data for a future time of interest may become available and an updated risk prediction may be calculated. Assuming there is sufficient new data, the new data may be fed into the existing predictive model to calculate a risk prediction (act 1122).

Whenever emergency data becomes available to check fit (e.g., the future time corresponding to the risk prediction has passed and actual emergency data is available), the algorithm may check the fit (act 1126). In some embodiments, the fit error may be calculated by comparing error predicted and actual emergency data values (act 1128). If the fit error is within acceptable limits, the model fit is good and the calculated risk prediction can be used to send warning signals.

If the fit error of the model is not within acceptable limits, the model may need to be updated. In some embodiments, the algorithm may generate a message for the Administrator indicating “prediction model fit is not within acceptable limits and the model may need to be updated” (act 1132). The acceptable limits of fit error may be defined by the Administrator (e.g., 0.5%, 1%, 2%, 5%, 10%, etc.).

In some embodiments, the algorithm may attempt to improve the fit by performing significance analysis for the predictor variables in the existing prediction model and eliminating one or more insignificant variables. First, an administrator may be prompted to guide the model update (adjustment of coefficients, intercepts and/or regeneration of model with different set of predictor variables, change data cut) (act 1138). Any known method for variable selection or elimination may be utilized such as forward selection, backwards elimination and stepwise regression, etc. In some embodiments, when the prediction model is a regression equation, other methods may be employed including data splitting, bootstrap, etc. After making changes to the variables, the algorithm may run the prediction algorithm to create a new or updated model using one or more algorithms (e.g., linear regression, geospatial regression analysis, non-linear regression, or one or more other forms of prediction algorithms such as machine learning, etc.) (act 1138). The algorithm may then perform significance analysis or testing to eliminate one or more insignificant variables (act 1134). The updated model may be used to re-calculate risk prediction (act 1136) and re-check the fit error (act 1128). In some embodiments, if subsequent iterations do not bring the fit error within acceptable limits, the algorithm may prompt the Administrator to guide the model update (e.g., adjustment of coefficients, intercepts and/or regeneration of model with different set of predictor variables, change data cut, etc.) to improve fit.

In some embodiments, if the fit model is within acceptable limits, the risk prediction calculated in act 1122, 1136 may be used for sending warning signals. In some embodiments, the risk prediction may be considered to be “high”, “elevated” or “excessive” based on pre-defined thresholds.

In some embodiments, once the computation is complete, the prediction algorithm may identify subjects via their communication devices. In some cases, subjects may be identified after collecting current subject data (not shown). For example, subjects in the geographic location, locational grid or locational boundary may benefit from updated emergency risk predictions from the updated prediction model. In some embodiments, the algorithm may make arrangements, via the EMS, the PSAP, or other communication devices, to send information regarding the updated emergency event predictions to the identified communication devices (not shown).

If the environmental information and call data from the EIS and EMS, respectively, have both not changed from the last known state, the algorithm may check the subject data from the communication devices for changes from the last known environmental data or emergency data (act 1118). If the subject data has new information that may be run in the prediction model and calculate a risk prediction (act 1122) and check model fit (act 1126, 1128). If the error fit is good, the algorithm may revert to data collection (act 1112). In addition, the prediction algorithm may return to act 1112 where the algorithm may poll EIS and the EMS for updated data after a pre-determined delay.

It is understood that the prediction algorithm described above may update in real time or periodically at defined intervals. For example, a defined interval may be about 1, 2, 3, 4, 5, 6, 7, 8, 9, 10, 11, 12, 13, 14, 15, 16, 17, 18, 19, 20, 21, 22, 23, or 24 hours. A defined interval may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes. For example, when new or updated forecast data is available for Thanksgiving morning, the algorithm may re-calculate a new risk prediction. If appropriate, updated warning signals may be sent to subjects and emergency service providers periodically or on demand. In some embodiments, subjects may receive real-time warnings while environmental data is changing rapidly. For example, recipients may receive updated warnings taking into account tornadoes, high winds, black ice, cold front, blizzards, thunderstorms, etc., that are approaching the subject's location. In contrast to general warnings based on the weather, the recipients (e.g., subjects or emergency service providers) receive these warnings based on actual emergency data, dynamic environmental data and subject data. By combining impact of so many factors together, the risk prediction is more realistic and may empower recipients to prevent and alleviate future emergency situations.

In one aspect, provided in the present disclosure is a method of generating and communicating a warning comprising a risk prediction to a subject communication device from a prediction server, the method comprising: (a) communicating, by the prediction server, with a first environment information server via a first application programming interface, the environment information server hosting current and historic data pertaining to environmental conditions in a geographic location of interest, the environmental conditions data including data regarding one or more of weather conditions, public event information, and road conditions; (b) receiving, by the prediction server, data pertaining to environmental conditions for a specified geographic location over a specified time period from the environment information server; (c) communicating, by the prediction server, with a first web server housed in an emergency management system (EMS), the web server containing data about the geographic location of origination and type and time of placement of emergency calls made from the geographic location; (d) receiving, by the prediction server data about the geographic location and times of placement of the emergency calls made from the geographic location from the first web server; (e) processing, by the prediction server, the information received from the environment information server and the first web server and using the information received from the environment information server and the first web server to make a risk prediction comprising a probability of occurrence of one or more emergency events within a defined time-frame and a geographic area likely to be impacted by the one or more emergency events; (f) generating, by the prediction server, a warning comprising the risk prediction comprising information about the one or more emergency events that are determined by the prediction server to have an higher than usual probability of occurrence and the geographic area predicted to be impacted by the one or more emergency events; (g) identifying, by the prediction server, a list of subjects of subject communication devices within the geographic area predicted to be impacted; and (h) conveying, by the prediction server, the warning to the subject communication devices of subjects in the list of subjects, over one or more data or voice communication links.

In some embodiments, the method further comprises including information, as provided by the EDC to the EMS, about ways to mitigate the possibility of adverse impact to the subjects of the subject communication device as a result of the increased possibility of the one or more emergency events in the warning conveyed to the subject communication devices.

In some embodiments, the method further comprises using an algorithm hosted on the prediction server that uses geospatial regression analysis to generate the warning based, at least in part, on a combination of knowledge of the history of the geographic locations of the emergency call requests and the knowledge of the values of the environmental variables of the same geographic area in the same time-frame as that of the emergency call requests.

In some embodiments, the conveying step further comprises the step of identifying the one or more emergency events as one or more climate related emergency situations, selected from the group consisting of snowstorms, earthquakes, thunderstorms, hurricanes, volcanic activity, excessive rain, high-wind speeds, and other inclement weather conditions.

In some embodiments, the conveying step further comprises identifying the one or more emergency events, included in the warning, as being related to situations involving humans and/or situations resulting as a direct result of human involvement.

In some embodiments, the conveying step further comprises identifying the one or more emergency events, included in the warning, as being one or more of theft assault, altercation, drug related offenses, events involving weapons, situations involving trespassing, public misconduct and events where one or multiple parties involved in the event are humans and humans are victims of the emergency situation.

In some embodiments, the generating step further comprises analyzing the temporal characteristics of the emergency calls made from the geographic location, including month, date, hour and minute and utilizing this information to generate a warning, based, at least in part on the temporal characteristics of the emergency calls made from the geographic location.

In some embodiments, the generating step further comprises analyzing spatial characteristics of the emergency calls made from the geographic location, including one or more of latitude and longitude of origination of one or more of the emergency calls, geographic location of origination of one or more of the emergency calls relative to a landmark including one of downtown and a downtown building, history of geographic locations of an object correlated with one or more of the emergency calls, and movement patterns of objects over a specified period of time correlated with one or more of the emergency calls, and utilizing the spatial characteristics of the emergency calls to generate a warning, based, at least in part on the spatial characteristics of the emergency calls made from the geographic location.

In some embodiments, the conveying step further comprises identifying one or more emergency events predicted to be related to a public event.

In some embodiments, the conveying step further comprises identifying one or more emergency events predicted to be related to a combination of a weather condition and the public event.

In some embodiments, the subject communication device communicates with the prediction server over the Internet, wherein the subject communication device formats and transmits information pertaining to an emergency situation to the prediction server over data communication channels.

In another aspect, provided in the present disclosure is a method of generating one or more risk predictions by a prediction server, comprising: (a) receiving, by the prediction server, real-time information pertaining to an emergency event from a subject communication device; (b) receiving, by the prediction server, data pertaining to environmental conditions for a specified geographic location over a certain time-period from an environment information server; (c) receiving, by the prediction server, data about geographic locations of emergency calls made from a certain geographic location from a web server housed in an EMS; processing, by the prediction server, the information received from the subject communication device in combination with information received from environment information server and the web server housed in the EMS and determining a value of the probability of occurrence of an emergency event within a defined time period in a defined geographic area; and (d) communicating, by the prediction server, the results of this processing via data communication channels to the subject communication device.

In some embodiments, the information received from the subject communication device pertains to types of emergency events related to a situation involving humans, a situation resulting as a direct result of human involvement, or a combination thereof.

In another aspect, provided in the present disclosure is a subject communications device comprising: a subject interface; and a processor configured to: (a) receive an indication of the location of the subject communication device from the location determination module; (b) establish a data communications link to an prediction server; (c) and receive a real-time information about possible emergency situations from the prediction server, interpret the information, and display the interpreted information to the subject of the subject communication device.

In another aspect, provided in the present disclosure is a prediction server, housed at one of an EDC, an EMS, and a location in the Internet, and comprising: (a) at least one first input/output (I/O) system configured to receive information pertaining to emergency situations, in the form of signals formatted to be sent over communication channels as data communication packets, from a subject communication device, the information including an indication of a location of the subject communication device and a type of emergency reported by a subject of the subject communication device; (b) at least one second input/output (I/O) system configured to receive environmental information including weather data, in the form of data communication packets, from an environment information server; (c) and at least one processing unit in communication with the at least one first I/O system and the at least one second I/O system and configured to: (i) receive information pertaining to emergency situations from the at least one first I/O system and interpret the data packets transmitted from the subject communication device; (ii) receive information pertaining to environment variables from the at least one second I/O system and interpret the data packets transmitted from the environment information server; (iii) and perform computing operations on the data received from the at least first I/O system and the at least one second I/O system and make the processed information available to the at least first I/O system for communication to external systems; (d) at least a first application programming interface (API), configured to receive and interpret signals formatted as data communication packets sent over a data communication channel from one or more of a subject communication device and an environment information server, the signals including data pertaining to emergency situations, the API configured to extract information including one or more of an indication of a location of the subject communication device, a type of emergency reported by a subject of the subject communication device, and environmental information including weather data reported by the environment information server, and to report this information to the at least one processing unit hosted in the prediction server; (e) a first database to store information regarding at least weather data from the environment information server and information received from the subject communication device; (f) and a prediction algorithm implemented in software configured to receive information from the API, receive information from the database, perform computations on the information received from the API and the database, and to communicate a result of the computation to the API.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In some embodiments, the non-volatile memory comprises magnetoresistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Example 1

Mrs. Jane Bond is in a Cubs baseball game in Chicago, while Mr. James Bond, an emergency response staff member or personnel, is at the EDC working. The EDC director wants to find out the probability of a possible incident, for example a riot at the stadium following the game, and sends Mr. Bond to investigate. Mr. Bond has access to a mobile application on his wireless phone, which enables him to communicate with an EMS comprising an emergency prediction system. Most of the people in the stadium carry mobile phones with them that have a pre-installed mobile application that periodically sends data comprising current location data to the EMS, which has a prediction server. This allows the EMS to use the real-time location of the people in the stadium to generate a locational map showing the density of all the people in the stadium whose wireless devices are in communication with the EMS and/or prediction server.

As the game progresses, the density map charts the movement of people in real-time as their devices continue to send updates on their current location. The EMS also has access to the past phone calls for emergency assistance requested within the vicinity of the stadium for multiple games, the type of emergency requested, and the crowd density at the location of the incident (historical event data). The prediction server obtains this historical event data (via a data module) from an EMS database. Using this past information and the current real-time situation, the prediction server is able to generate a prediction model and use it to generate a prediction of the likelihood of occurrence of an emergency situation (risk prediction).

An Admin at the EMS enters instructions to the prediction server to generate a prediction model by analyzing the historical event data using Multiple Linear Regression. The prediction server modeling module then generates a prediction model having a formula: number of emergency calls=IC+b1*(crowd movement)+b2*(game outcome)+b3*(amount of alcohol sold).

IC is the intercept, and b1, b2 and b3 are the coefficients to the variables “crowd movement,” which is the real-time movement of people, “game outcome,” which is the result of the on-going match, and “amount of alcohol sold,” which is the amount of alcohol sold for consumption by the people at the stadium, respectively. Crowd movement is calculated based on the average movement of the people at the stadium using the time and location data of their periodic updates sent from their communication devices. Game outcome may be assigned a value depending on a win or loss for the home team. Amount of alcohol sold may be calculated using data obtained from servers or database maintained by the stadium management.

Based on the above example equation, the workers at the EDC, the EMS Admin, or Mr. Bond may obtain a prediction of the likelihood of occurrence of an emergency event at the stadium by providing real-time information about the three variables, which are obtained from the user communication devices. When the predicted number of calls exceeds a certain predefined threshold (e.g. by a 3-fold margin over a baseline predefined risk threshold), Mr. Bond raises raise an alarm and inform his friends at the EDC to allocate more emergency response personnel to be stationed at or near the stadium, alert the stadium management to take precautions, and send a warning or message to individuals in or around the stadium such as Mrs. Jane Bond. The warning may contain information on the probability of such an incident (risk prediction) and any necessary precautions that might help her lower her risk exposure. The EDC, EMS, or the prediction server communication module itself then transmits the warning comprising the elevated risk information to certain individuals at or near the stadium via a text message or a MMS or another form of instant communication.

Further, if an individual in the stadium, for example, Mrs. Jane Bond, observes certain irregularities such as a fire in a certain part of the stadium, she can send this information to the EMS or directly to the prediction server via the application on her phone, which the prediction server can include in the prediction model. For example, the prediction model may be updated to reflect this new variable/parameter by generation of a new prediction model that accounts for a “fire” variable having the formula: number of emergency calls=IC+b1*(crowd movement)+b2*(game outcome)+b3*(amount of alcohol sold)+b4*(whether there is a fire inside the stadium). The presence of a fire may have been found to have a strong correlation with the risk of a stampede by the crowd in the stadium, and thus would be valuable information relevant to the generation of a new risk prediction. The new prediction model may then calculate a new risk prediction comprising the possibility of an incident such as a stampede. The prediction server communication module may then send a warning to individuals in the stadium to remain calm and an warning to the EMS, EDC, local government emergency response personnel, and/or stadium management team or security personnel of the risk prediction and accompanying information (e.g. the presence of a fire in the stadium and its time and location).

For anyone experienced in the art it is apparent that other variables, in addition or in place of, the variables expressed in the equation above in order to predict an emergency situation.

What is claimed is:

1. A computer-implemented emergency prediction system comprising: a digital processing device comprising: at least one processor, an operating system configured to perform executable instructions, a memory, and a computer program including instructions executable by the digital processing device to create an application applying a prediction algorithm to emergency, environmental, and event data to create a prediction model for generating one or more risk predictions, the application comprising:
a) a data module obtaining emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events;
b) a modeling module applying a prediction algorithm to the emergency data, environmental data, and event data to create at least one prediction model for generating at least one risk prediction, wherein the modeling module updates the at least one prediction model to improve prediction accuracy; and
c) a risk module generating a risk prediction by applying the at least one prediction model to data corresponding to a defined emergency, a defined geographic area, and a defined time period.

2. The system of claim 1, further comprising a communication module sending a warning to one or more subjects located within the defined geographic area during the defined time period when the risk prediction corresponding to the defined emergency, the defined geographic area, and the defined time period exceeds a defined risk threshold.

3. The system of claim 2, wherein the communication module sends one or more warning updates to said one or more subjects.

4. The system of claim 2, wherein the defined risk threshold comprises an average of a plurality of risk predictions corresponding to the defined geographic location.

5. The system of claim 2, wherein the communication module obtains subject data from one or more subject communication devices.

6. The system of claim 5, wherein the subject data comprises current location at a current time for one or more subjects.

7. The system of claim 5, wherein the subject data comprises a future location at a future time for one or more subjects.

8. The system of claim 7, wherein the future location at the future time is calculated using current subject data, historical subject data, or a combination thereof.

9. The system of claim 7, wherein the future location at the future time is calculated using subject location, direction of travel, speed of travel, path of travel, mode of transportation, or any combination thereof.

10. The system of claim 1, wherein the defined time period comprises at least one time block, wherein a 24 hour time period is divided into a plurality of time blocks.

11. The system of claim 1, wherein the emergency type is selected from the group consisting of: vehicle emergency, fire emergency, police emergency, and medical emergency.

12. The system of claim 1, wherein the environment data comprises future environment data for the plurality of environmental conditions.

13. The system of claim 12, wherein the future environment data for each of the plurality of environmental conditions comprises an environment type at an environment location during an environment time, wherein the environment time comprises a future time.

14. The system of claim 1, wherein the event type is selected from the group consisting of: concert, sporting event, political demonstration, festival, performance, riot, protest, parade, convention, and political campaign event.

15. The system of claim 1, wherein the system provides one or more risk predictions to one or more emergency management systems or emergency dispatch centers, wherein the risk predictions enhance allocation of emergency response resources in preparation for future emergency requests.

16. The system of claim 1, wherein the system provides one or more risk predictions to an emergency management system or emergency dispatch center autonomously without requiring instructions requesting one or more risk predictions.

17. The system of claim 1, wherein in (b) the prediction algorithm comprises generating the prediction model using regression statistical analysis on the emergency data, environmental data, and event data, wherein the statistical analysis is selected from linear regression, logistic regression, polynomial regression, stepwise regression, ridge regression, lasso regression and ElasticNet regression.

18. The system of claim 1, wherein in (b), the modeling module assigns the risk prediction an accuracy score by comparing the risk prediction to an actual risk, wherein the actual risk corresponds to the defined emergency, the defined geographic area, and the defined time period.

19. Non-transitory computer-readable storage media encoded with a computer program including instructions executable by at least one processor to create an emergency prediction application applying a prediction algorithm to emergency, environmental, and event data to create a prediction model for generating one or more risk predictions, the application comprising:
a) a data module obtaining emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events;
b) a modeling module applying a prediction algorithm to the emergency data, environmental data, and event data to create at least one prediction model for generating at least one risk prediction, wherein the modeling module updates the at least one prediction model to improve prediction accuracy; and
c) a risk module generating a risk prediction by applying the at least one prediction model to data corresponding to a defined emergency, a defined geographic area, and a defined time period.

20. A method of using a digital processing device to apply a prediction algorithm to emergency, environmental, and event data to create a prediction model for generating one or more risk predictions, the method comprising:
a) receiving, by the device, emergency data, environmental data, and event data, the emergency data comprising emergency type, emergency location, and emergency time for a plurality of emergencies, the environmental data comprising environment type, environment location, and environment time for a plurality of environmental conditions, and the event data comprising event type, event location, and event time for a plurality of events;
b) applying, by the device, a prediction algorithm to the emergency data, environmental data, and event data to create at least one prediction model for generating at least one risk prediction, wherein the device updates the at least one prediction model to improve prediction accuracy; and
c) generating, by the device, a risk prediction by applying the at least one prediction model to data corresponding to a defined emergency, a defined geographic area, and a defined time period.
